(19) United States
(12) Patent Application Publication
(10) Pub. No.: US 2001/0054064 A1
(43) Pub. Date: Dec. 20, 2001

(54) METHOD SYSTEM AND COMPUTER PROGRAM PRODUCT FOR PROVIDING CUSTOMER SERVICE OVER THE WORLD-WIDE WEB

(76) Inventor: PALLIPURAM V. KANNAN, LAWRENCEVILLE, NJ (US)

Correspondence Address: STATTLER JOHANSEN & ADELI, P O BOX 51860, PALO ALTO, CA, 94303

(21) Appl. No.: 09/106,011

(22) Filed: Jun. 29, 1998

Related U.S. Application Data
(60) Provisional application No. 60/085,812, filed on May 18, 1998.
(60) Provisional application No. 60/052,779, filed on Jul. 2, 1997.
(60) Provisional application No. 60/052,252, filed on Jul. 11, 1997.

(51) Int. Cl. G06F 15/16

(52) U.S. Cl. 709/203; 709/218

(57) ABSTRACT

A method, system, and computer program product provides live customer service between a customer and a CSR in real-time over the World Wide Web. Customer service for the Web is provided which is secure, private and responsive to particular customer needs. Queries sent by potential customers browsing a Web site are intelligently routed to appropriate customer service representatives. Potential customers browsing a Web site are also intelligently routed to appropriate customer service representatives. A memory coupled to a server stores a CS enabled Web site having a service applet. When a customer browses the CS-enabled Web site, the service applet is downloaded and executes in a customer computer to support the live customer service. The server executes a customer service agent. The customer service agent enables a customer service window to be displayed by the customer browser. A CSR window is displayed on a browser of the CSR. The customer service agent and service applet determine whether a customer qualifies for live customer service. The level of customer service to be provided can be based at least upon one of the following: browsing data gathered while the customer browses the CS enabled Web site; a customer profile; and a policy of the CS enabled Web site. The customer service window can include a service dialog window and/or a service form. Polling allows a customer to be notified while the customer is browsing the Web that a CSR has chosen to respond to the query input by the customer. Messages are encapsulated/de-encapsulated in HyperText Transport Protocol (HTTP) to pass through Internet firewalls. Secure communication for Web-based customer service is provided. Communication between the customer and the CSR can be supervised and customer service performance can be tracked.

This application claims the benefit of priority to three provisional applications by Pallipuram V. Kannan: (1) “Method, System, and Computer Program Product for Providing Customer Service over the World Wide Web,” (Appl. Ser. No. 60/085,812), filed May 18, 1998; (2) 60/052,779 filed Jul. 2, 1997; and (3) 60/052,252, filed Jul. 11, 1997, each of which are incorporated by reference herein in their entirety.

### BACKGROUND OF THE INVENTION

1. Field of the Invention

The present invention relates generally to computer networking and communication. More particularly, the present invention pertains to customer service in Web-based communications and commerce.

2. Related Art

The World Wide Web is increasingly becoming the Internet technology relied upon for conducting electronic commerce. The World Wide Web, also called the Web or WWW, has three basic parts: client software, servers and content. Client software runs on a user's computer and, among other things, provides the graphical user-interface through which a user can “browse” or “surf” the Web. Servers (also called Web servers) are computers that provide the content to users through a communication link. Content can be any kind of multi-media, e.g., images, text, animation, motion video, sound, and Java applets. Communication between a browser and a server is carried out through a Hyper Text Transfer Protocol (HTTP). Web content is primarily transferred in Web documents or files, called Web pages, which are addressed by a Uniform Resource Locator (URL). Web pages are often multi-media hypertext documents written in a HyperText Markup Language (HTML) which supports hyper-linking. See, e.g., Hoffman, Netscape and the World Wide Web for Dummies, 2nd Ed., (IDG Books World Wide, Inc.: U.S.A. 1996), pp. 11-61 (incorporated herein in entirety by reference).

These parts are well-suited for electronic commerce or Web commerce. Many merchants or sellers advertise their products on Web pages. Potential customers shop by visiting the Web pages of interest to check out products and services being offered. Different types of on-line malls and markets and other business services and associations have evolved on the Web. See, Hoffman at pp. 173-188. A few companies have attempted to create a community of users using “chat” and other real-time communication tools. These require a web visitor to move to a special unsecure area and chat with other visitors or with a company representative. Such chat is not effective for electronic commerce over the Web because the chat may not be private or secure. Many customers may not feel secure when others are present in the chat areas to obtain customer service using a text based chat user interface.

Data entry is possible through a Common Gateway Interface (CGI) approach. The Java programming language provides both secure communication and supports data entry. Such data entry or user input is especially important in Web commerce and Java commerce. Data entry allows users to fill-out and send order forms or customer profiles to sellers. In Java commerce, users can also fill up shopping carts and can carry out commercial transactions, such as credit-card transactions and other purchases. See, Jardin, Java Electronic Commerce Sourcebook: All the Software and Expert Advice You Need to Open Your Virtual Store, (Wiley Computer Publishing: U.S.A. 1997), the entire book (incorporated in its entirety herein by reference); and U.S. Pat. Nos. 5,715,314; 5,724,424; and 5,708,780 assigned on their face to Open Market, Inc.

However, customer service needs to be provided on-line, live, and in realtime over the Web. Such on-line, live customer service in real-time is essential to further promote electronic commerce over the World Wide Web. Effective customer service must instill confidence between a potential on-line customer and a seller. To instill confidence requires effective communication which emulates human-to-human interaction in real-time.

Communication between a customer and a seller must be clear and responsive. A customer needs sufficient information about product or service to have confidence that the product or service will meet the customer's needs. A seller can advertise a product or service on a Web page or site, but a customer needs to be able to ask questions. The flexibility and response of human-to-human interaction is needed.

Communication between a customer and a seller must also be secure and private (one-to-one). In this way, parties can ask questions and exchange personal data, credit card information, etc. to complete the commercial transaction.

Further, it is desirable that communication for customer service be able to pass through firewalls. In this way, a large customer base can be reached, including potential customers which access the Internet via a proxy server and firewall.

Different networking tools or services allow remote users to communicate with each other over a communication link. However, such tools cannot provide effective on-line, live customer service in real-time over the World Wide Web. These tools are either unavailable for World Wide Web applications or do not allow clear, responsive, secure, and private communication and real-time, human-to-human interaction which is vital to instilling confidence in a commercial transaction.

For example, electronic mail (e-mail) services allow users to send text messages and files to each other. To send e-mail, a sender must know beforehand a receiver's network address. In WWW applications, a potential customer browsing a Web site must know or be able to select a customer representative's e-mail address. This can limit the routing of a potential customer query to an appropriate CSR or the routing of a potential customer to an appropriate CSR. E-mail services are also fairly insecure. See, Krol, The Whole Internet: User's Guide and Catalog, Second Ed. (O'Reilly & Associates, U.S.A.: April 1994) Chapter Seven, pp. 101-150 (incorporated by reference herein in its entirety).

E-mail services also operate as store-and-forward services separate from World Wide Web applications. See, e.g., “Wired Customer Service” (http://www.wired.com/wired/customer_service, downloaded May 15, 1998). Because the transfer of e-mail messages involves many store and forward operations, a direct question and answer exchange (where the Q and A are kept together) between a potential customer and CSR cannot be assured while the customer is browsing. Finally, because e-mail messaging is separate from WWW applications, contextual information regarding the Web page is absent from the e-mail message. A customer cannot just type a query to a CSR as the CSR will not be able to immediately associate contextual information from the Web page that the customer is visiting. Thus, conventional e-mail services do not provide effective live customer service in real-time over the World Wide Web.

Similarly, telephone numbers of CSRs have been provided at Web sites for customer service. See, e.g., “Wired Customer Service” (http://www.wired.com/wired/customer_service, downloaded May 15, 1998). However, this requires a potential customer to place a separate phone call. Such a call may not even be able to be made while the customer is browsing if an additional phone line is not available. Because the phone call is separate from Web browsing, the contextual information regarding the Web page is also not communicated to a CSR without further input or description by the user.

Internet chat programs have been used as well to provide limited customer service over the WWW. For example, a Web site is provided with a “Help” or “Customer Service” button. When a customer browsing the Web site presses the Help button for service, the customer is sent to a chat room to converse with a CSR. Such chat rooms, however, are not private or secure. Chat rooms are essentially a form of “many-to-many” communication. In a chat room, each customer query and a response by a CSR can be seen by all chat room participants.

Similarly, other Internet services, such as, Internet Relay Chat (IRC) or newsgroups, are not suitable for providing customer service in commerce over the Web. IRC broadcasts messages to anyone logged on to IRC. See, Krol at pp. 342-346. In newsgroups, messages are posted and available to all newsgroups users. See, Krol, at pp. 151-185. Enhanced IRC, I-chat, and Palace services provide talk services but do not have adequate security or privacy and do not allow point-to-point communication behind firewalls.

What is needed is an invention which provides on-line, live customer service between a potential customer and a customer service representative over the World Wide Web in real-time. Customer service is needed which is secure and responsive to particular customer needs. Customer service channeled through secure, private, human-to-human communication between a browsing customer and a CSR in real-time over the Web is needed.

### SUMMARY OF THE INVENTION

The present invention provides on-line, live customer service between a potential customer and a customer service representative over the World Wide Web in real-time. Customer service for the Web is provided which is secure and responsive to particular customer needs. Customer service is channeled through secure, private, human-to-human communication between a browsing customer and a CSR in real-time over the Web.

Queries sent by potential customers browsing a Web site are intelligently routed to appropriate customer service representatives. Potential customers browsing a Web site are also intelligently routed to appropriate customer service representatives.

The present invention includes a method, system, and computer program product for providing live customer service between a customer and a CSR in real-time over the World Wide Web. In one embodiment, a server is linked to first and second computers over the WWW. The first computer supports a customer browser. The second computer supports a CSR browser. A memory coupled to the server stores a CS enabled web site having active content, such as, a service applet.

When a customer browses the CS-enabled web site, the active content is downloaded and executes in the first computer to support the live customer service. The server executes a customer service agent. In one example, the customer service agent is a computer program. The customer service agent enables a customer service window to be displayed by the customer browser. The customer service agent receives a query input in the customer service window by the customer and routes the received query to a CSR. The customer service agent enables a CSR window including the received query to be displayed on a browser of the CSR and sends a response input in the CSR window by the CSR to the browser of the customer.

In one example implementation according to the present invention, the customer service agent further comprises a service manager, a matcher, and a dialog manager. The service manager enables the customer service window to be displayed by the customer browser and stores the query input in the customer service window by the customer in a first queue. The matcher matches the stored query in the first queue to a CSR and stores transfers the query into a second queue. The service manager further enables a CSR window including the query stored in the second queue to be displayed on the browser of the CSR and transfers control to the dialog manager after the matcher has stored the query in the second queue. The dialog manager sends the response input in the CSR window by the CSR to the browser of the customer while the customer browses the World Wide Web.

Similarly, in one embodiment a method is provided according to the present invention that includes the step of enabling a web site for live customer service (CS). For example, to enable a web site for live service, a customer service agent is provided at a Web server hosting the web site. Active content is provided in a web page at the web site. The customer service agent executes in response to a customer browsing the CS enabled web site. The active content can be a service applet that executes to read customer profile data, to encapsulate and de-encapsulate messages in HTTP, and to poll the web site.

The method enables a customer service window to be displayed on a browser of the customer visiting the CS enabled web site. The customer service agent and service applet can determine whether a customer qualifies for live customer service. The customer service window can be opened by the customer. Alternatively, the customer can be prompted for customer service. While a customer browses the CS enabled web site, browsing data is gathered. The customer can be prompted for live customer service based on the gathered browsing data. For example, a prompt may be made when the customer is switching back and forth between Web pages, or is delaying at a given Web page.

The method further generates a customer profile. The level of customer service to be provided can be based at least upon one of the following: browsing data gathered while the customer browses the CS enabled web site; a customer profile; and a policy of the CS enabled web site. The contents of the customer service window can be set based on the level of customer service to be provided.

For example, the customer service window can include a service dialog window and/or a service form to be displayed on a browser of the customer visiting the CS enabled web site. In one example, the customer service window includes a service dialog window when an express interactive customer service is provided. A service dialog window and a service form are used when a full interactive customer service is provided. In another example, the method initially enables a service dialog window to be displayed on a browser of the customer visiting the CS enabled web site to exchange messages with a CSR; and subsequently enables a service dialog window and a service form to be displayed on the browser of the customer visiting the CS enabled web site when a transaction is to be completed which is more complex than exchanging messages.

According to the method of the present invention, a query input in the customer service window by the customer is received at a server and routed to a CSR. A CSR window that includes the received query is enabled to be displayed on a browser of the CSR. The routing step comprises intelligently routing the query to a CSR based on at least one of the following criteria: content, context, question, and qualifications. In one example implementation, the intelligently routing step includes the steps of storing the query and a corresponding customer URL in a queue of pending customer queries; matching the stored query to a CSR based on at least one of the following criteria: content, context, question, and qualifications; and storing the query in a service queue capable of being displayed in the CSR service window by the matched CSR.

According to one example, a CSR window is enabled to be displayed that allows a CSR to access at least one of the following: data in the customer profile, a list of scripts, and a list of recommended answers. For example, the CSR window to be displayed can include a service dialog window, a comments window, a response entry window, and a menu bar having at least the following group of buttons: Queue button, Customer Details button, Recommend Answers button, Update Customer Profile button, and a Scripts button. The query can be analyzed dynamically against a knowledge base to generate a list of recommended answers for display in the CSR window. These tools assist the CSR in formulating an effective and accurate response and help ensure a consistent response is formulated. A response input in the CSR window by the CSR is received by a server and is sent to the browser of the customer.

Once a customer has sent a query a customer can maintain his or her browser pointed at the same web site (URL address) to ensure that an HTTP connection is maintained. Alternatively, according to a further feature of the present invention , the customer can send a query and while waiting for a response continue to browse the World Wide Web or do something else. The customer service agent will then notify the customer that a CSR has picked up the query or has sent a response. For example, the customer can browse other Web sites and then be notified that the CSR has picked up the customer. The customer can also performed other unrelated computer tasks. For example, the customer can minimize the browser and switch to a different application and still be notified that CSR has picked up the customer.

The ability to notify the customer is achieved using a polling feature of the present invention which establishes a quasi-persistent link. The quasi-persistent link can be established even in a HTTP environment where a connection is closed after a message is sent or received. According to this feature, the method polls the web site after the query is input in the customer service window. The polling allows a customer to be notified while the customer is browsing the Web or performing another task that a CSR has chosen to respond to the query input by the customer. In this way, a quasi-persistent communication link can be established between a browsing customer and a server (and a CSR) even in a Web environment using HTTP where communication between a browser and a server occurs as a series of discrete temporary connections.

The method further includes the step of managing a dialog between the customer and the CSR once a CSR has picked up a customer. According to a further feature, steps are included for encapsulating and de-encapsulating messages in HyperText Transport Protocol (HTTP) messages sent to and from the customer browser and/or the CSR browser. For example, such steps can include encapsulating the query input in the service window into a HTTP message prior to sending the query input from a computer at the customer browser; encapsulating the response from the CSR into a HTTP message prior to sending the response to the computer at the customer browser; and de-encapsulating the HTTP message received at the computer at the customer browser to extract the response. In this way, communication can occur through a firewall that allows HTTP traffic to pass. Secure communication is attained because the present invention can incorporate a Secure Socket Layer or other Web security technique.

The method can also include the steps of supervising communication between the customer and the CSR and tracking customer service performance.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the pertinent art make and use the invention.

FIGS. 1-4 illustrate an example Internet architecture and example Internet services including the World Wide Web.

FIG. 1 is a diagram showing different types of users and communications which can be connected over an Internet architecture.

FIG. 2 shows a communication model supporting Web commerce.

FIG. 3 shows an example of an Internet network supporting Web commerce.

FIG. 4 shows an example of Java enabled browsers coupled to a Web server for reading Web pages and Java files, including interpreting and loading applets embedded in HTML documents.

FIG. 5A is a block diagram showing components for providing live customer service over the Web according to one embodiment of the present invention.

FIG. 5B shows an example architecture for providing live customer service in a full customer service center according to one example implementation of FIG. 5A.

FIG. 6 is a diagram of a customer service agent and customer and CSR browsers according to one example implementation of the present invention.

FIGS. 7A and 7B show a routine for providing live customer service according to one embodiment of the present invention.

FIGS. 8A and 8B are flowcharts showing steps in FIG. 7B in further detail according to one example of the present invention.

FIG. 9 shows a customer service window that includes a service dialog window according to an example of the present invention.

FIG. 10 shows an example customer service window including a service dialog window and a service form.

FIG. 11 shows examples of authorization and registration forms.

FIG. 12 shows an example customer service representative window used in a full customer service center embodiment of the present invention.

FIG. 13 shows an example customer service representative window used in an express customer service embodiment of the present invention.

FIGS. 14A, 14B, 14C, 14D, 14E, 14F, 14G, 14H, 14I, 14J, 14K, 14L, 14M, 14N, and 14O are screen displays illustrating an example of live customer service supporting online travel reservations according to the present invention.

FIGS. 15A, 15B, 15C, 15D, 15E, 15F, and 15G are screen displays illustrating an example of a supervisor interface monitoring the live customer service in FIGS. 14A-14O according to the present invention.

FIG. 16 shows an example routine for providing customer service over the Web according to another embodiment of the present invention.

FIG. 17 illustrates an example of HTTP tunneling whereby messages encapsulated in HTTP can pass through firewalls.

FIG. 18 is a block diagram of a computer system according to an example implementation of the present invention.

The present invention will now be described with reference to the accompanying drawings. In the drawings, like reference numbers indicate identical or functionally similar elements. Additionally, the left-most digit(s) of a reference number typically identifies the drawing in which the reference number first appears.

### DETAILED DESCRIPTION OF THE FIGURES

Overview and Terminology

The present invention provides a method, system, and computer program product for on-line, live customer service over the World Wide Web (WWW) in real-time. The term “on-line” refers to communication over a computer network. The term “live” refers to communication between a customer and a customer service representative including humans and/or automated agents such as a robotic interface. The term “real-time” means information, such as a customer query and a CSR response, can be exchanged in a round-trip cycle between a customer and a customer service representative with little or no delay such as within seconds or minutes (any delay being substantially a function of the communication medium and devices connected between customer and CSR) .

The present invention is described with respect to customer service over the WWW. In general, the present invention is not so limited and can be applied to provide and support any communication over the WWW including person-to-person communication unrelated to customer service. Further, the present invention is not limited to the Web and, in general, can be applied to provide and support any communication over any interactive, computer networking service, including but not limited to the Web.

Example Environment

The present invention can be implemented in any communication network, such as, the Internet, which supports interactive services and applications. In particular, the present invention can be implemented in any Web service, preferably a Web service supporting secure transactions, such as, the Secure Socket Layer (SSL) protocol and/or using a Secure HyperText Transport Protocol (S-HTTP). In one example, the present invention is implemented in a multi-platform (platform independent) programming language such as Java 1.1. Java-enabled browsers are used, such as, Netscape, HotJava, and Microsoft Explorer browsers. Active content Web pages are used. Such active content Web pages can include Java applets or ActiveX controls, or any other active content technology developed now or in the future. The present invention, however, is not intended to be limited to Java or Java-enabled browsers, and can be implemented in any programming language and browser, developed now or in the future, as would be apparent to a person skilled in the art given this description.

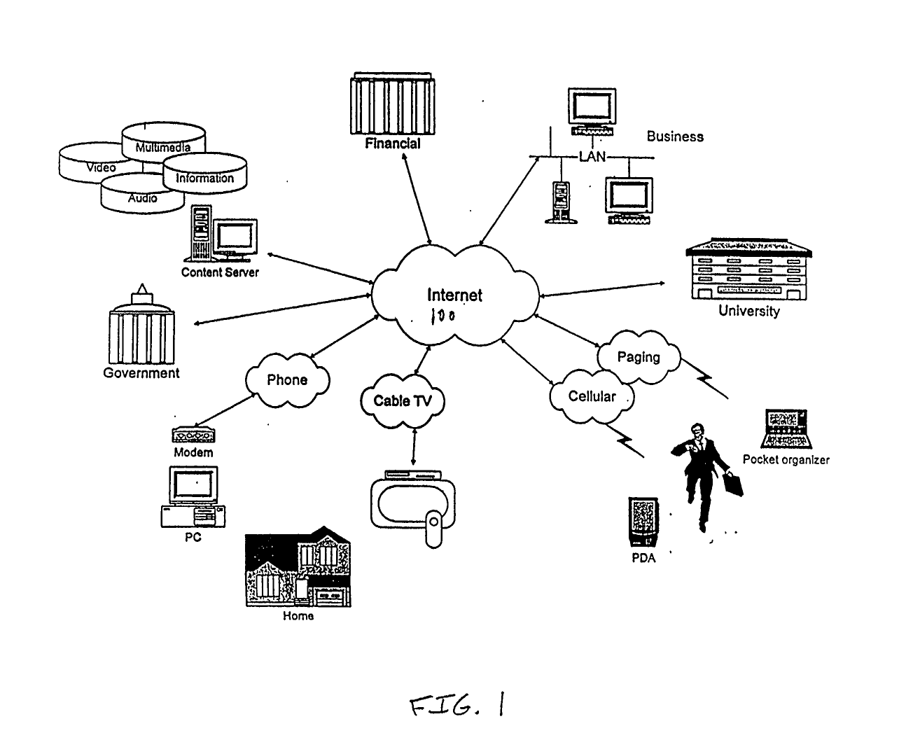

For example, FIG. 1 shows a communication network, Internet 100, which can support the invention. Internet 100 consists of interconnected computers which supports communication between many different types of users including businesses, universities, individuals, government, and financial institutions. Internet 100 supports many different types of communication links implemented in a variety of architectures. For example, voice and data links can be used including phone, paging, cellular, and cable TV (CATV) links. Terminal equipment can include local area networks, personal computers with modems, content servers of multi-media, audio, video, and other information, pocket organizers, Personal Data Assistants (PDAs), and set-top boxes. See, for example, Martin, J., TCP/IP Networking Architecture, Administration, and Programming, PTR Prentice-Hall, Inc., New Jersey (1994) (incorporated in its entirety herein by reference); and Lee et al., Intellectual Property for the Internet (John Wiley & Sons: U.S.A. 1997), p. 4.

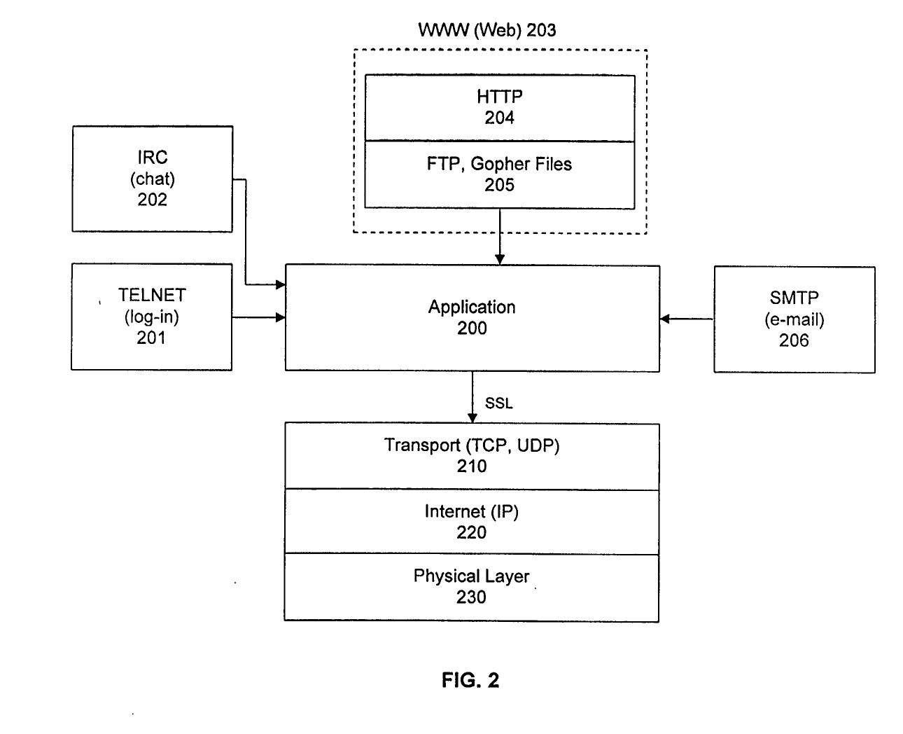

Communication over a communication network such as Internet 100 is carried out through different layers of communication. FIG. 2 shows a simplified four-layered communication model supporting Web commerce including an application layer 200, transport layer 210, Internet layer 220, physical layer 230. As would be apparent to a person skilled in the art, in practice, a number of different layers can be used depending upon a particular network design and communication application. See, E. Harold, Java Network Programming (O'Reilly & Associates, Inc.: U.S.A. 1997), pp. 1-55 (incorporated in entirety herein by reference). Application layer 200 represents the different tools and information services which are used to access the information over the Internet. Such tools include, but are not limited to, telenet log-in service 201, IRC chat 202, Web service 203, and SMTP (Simple Mail Transfer Protocol) electronic mail service 206. Web service 203 allows access to HTTP documents 204, and File Transfer Protocol (FTP), and Gopher files 208. See, Liu et al., Managing Internet Information Services (O'Reilly & Associates, U.S.A.: April 1994) p.287 (incorporated by reference herein in its entirety). A Secure Socket Layer (SSL) is a protocol used to encrypt communications between a Web browser and Web server. See, L. Stein, Web Security: A Step-By-Step Reference Guide (Addison-Wesley: Reading, Mass. 1998), pp. 36-47 (incorporated by reference herein in its entirety).

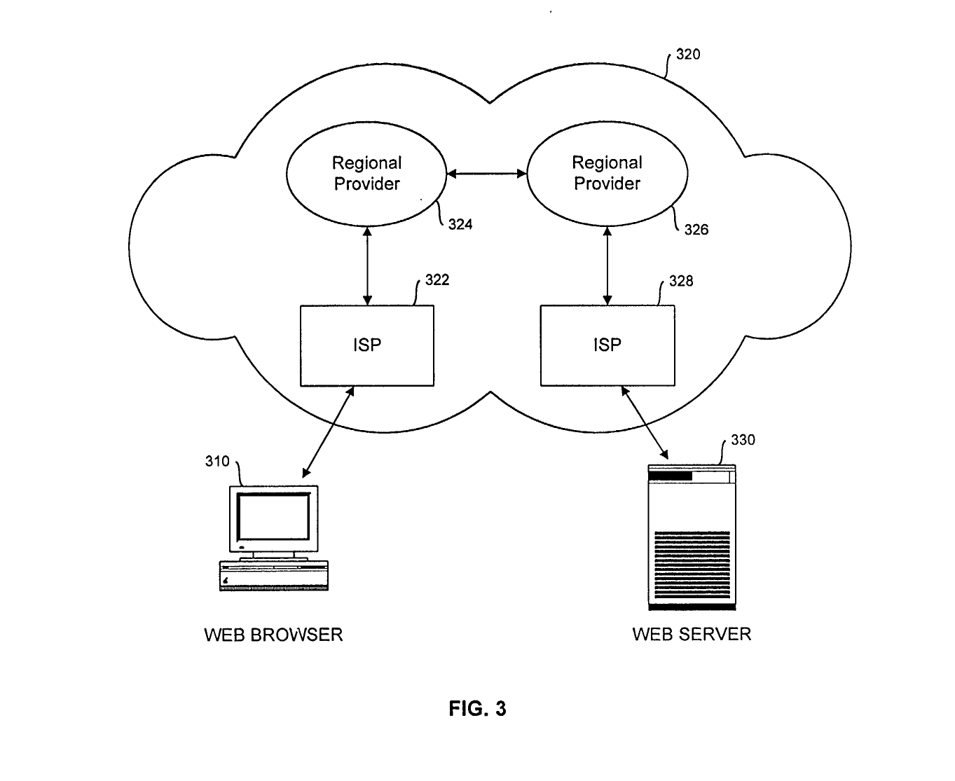

FIG. 3 shows an example of an Internet network 320 supporting Web service 203. A Web browser 310 is connected to a Web server 330 through Internet network 320. An Internet Service Provider (ISP) 322 links the computer of Web browser 310 to Internet network 320. ISP 328 links Web server 330 to Internet network 320. Regional service providers 324, 326 and other intermediaries (not shown) route traffic between ISPs 322 and 328. See, L. Stein at p. 5.

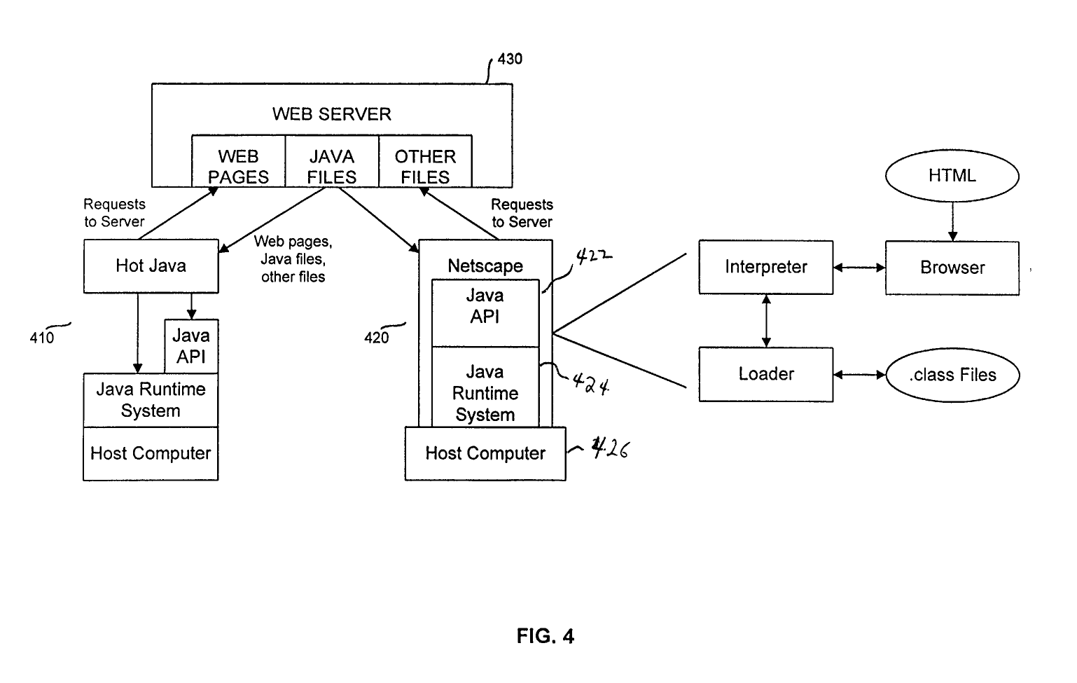

FIG. 4 shows how Java-enabled browsers (HotJava 410, Netscape 420) interact with a Web server 430 to make requests to the server and to download interactive Web pages including Java files and other files. For example, a Java-enabled Netscape browser 420 includes a Java API 422 and Java runtime system 424 supported by a host computer 426. When a Netscape browser 420 with a Java API 422 encounters an applet tag in an HTML Web page, a corresponding .class file for executing the applet is loaded into the host computer 426 and interpreted to a byte code file. A Java runtime system 424 executes the byte code file to display on the host computer 426 the Web page with the active content of the applet. See, J. Jaworski, Java 1. 1: Developer's Guide, 2^{nd} Ed. (Sams.net Publishing: U.S.A.: 1997), pp. 9 and 750 (incorporated in its entirety herein by reference).

Description of the example environment in these terms is provided for convenience only. It is not intended that the invention be limited to application in this example environment. In fact, after reading the following description, it will become apparent to a person skilled in the relevant art how to implement the invention in alternative environments.

Live Customer Service over the Web

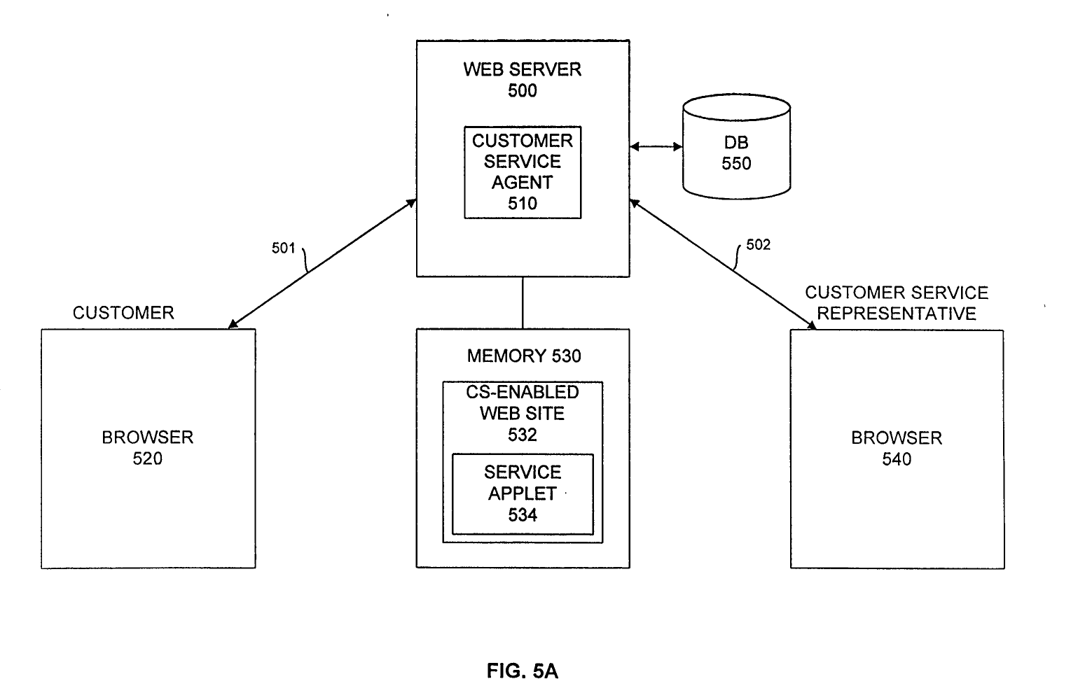

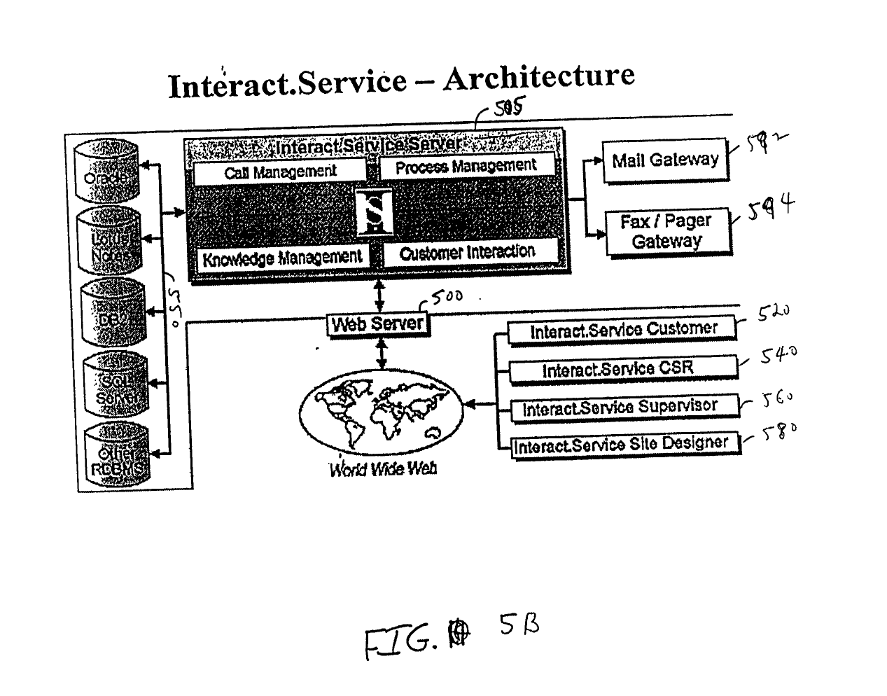

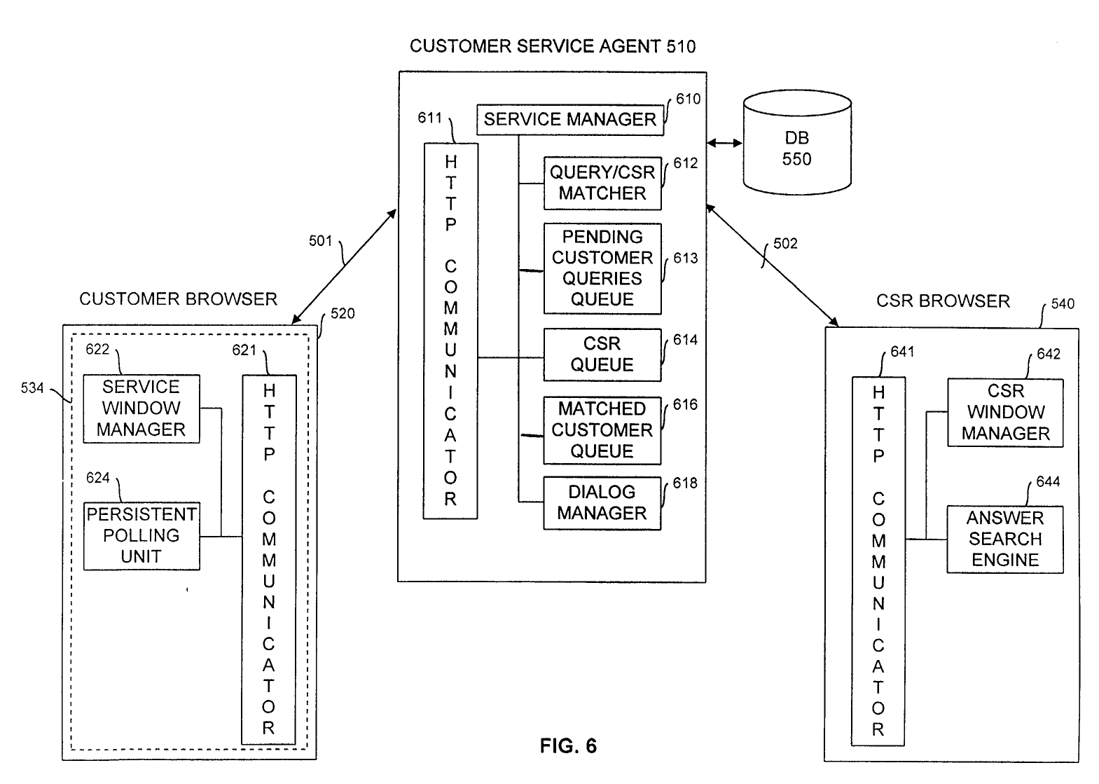

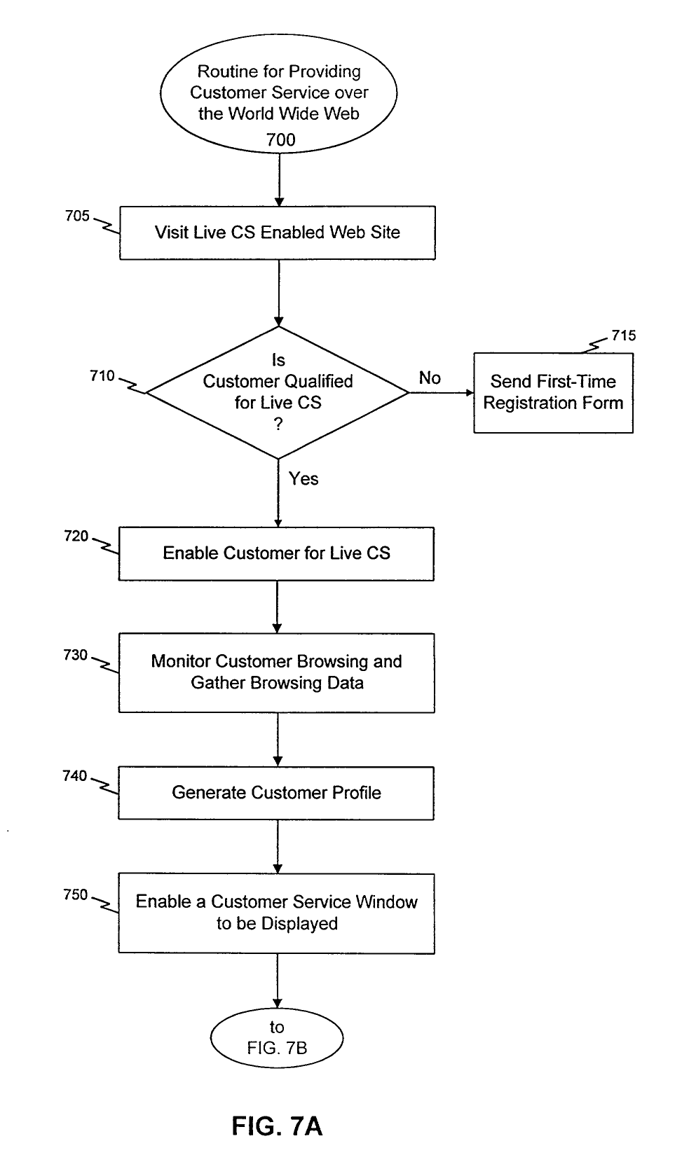

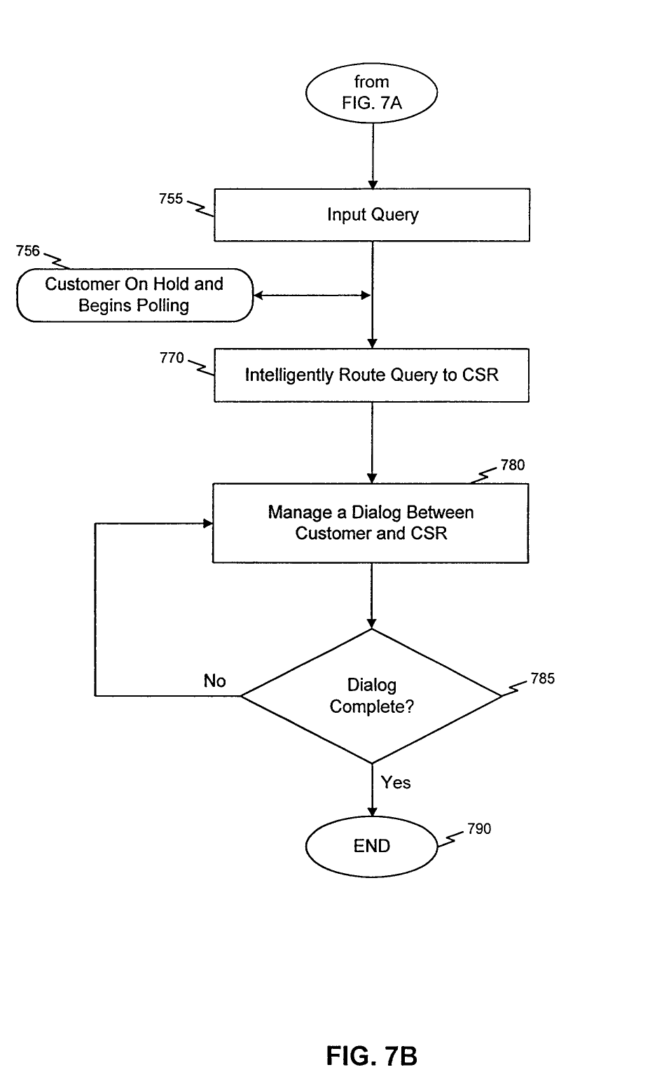

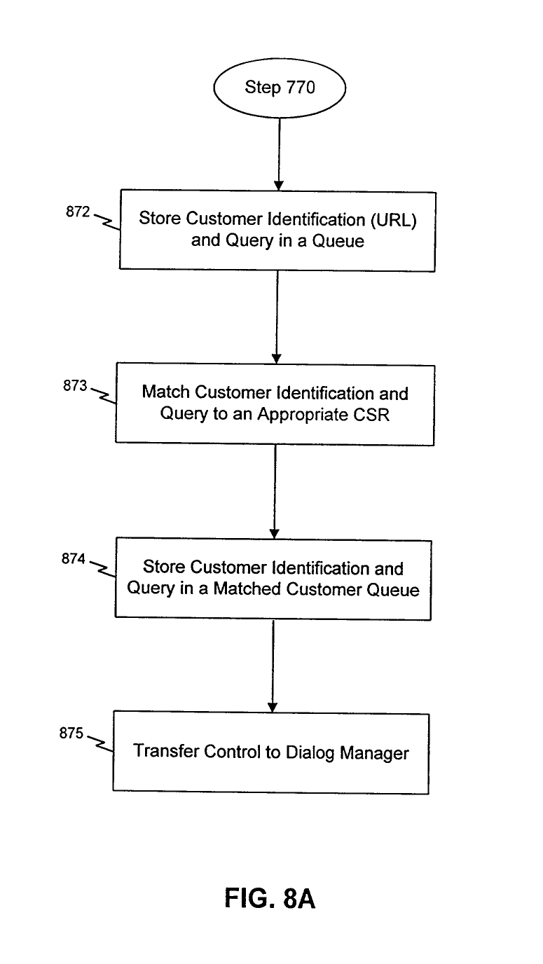

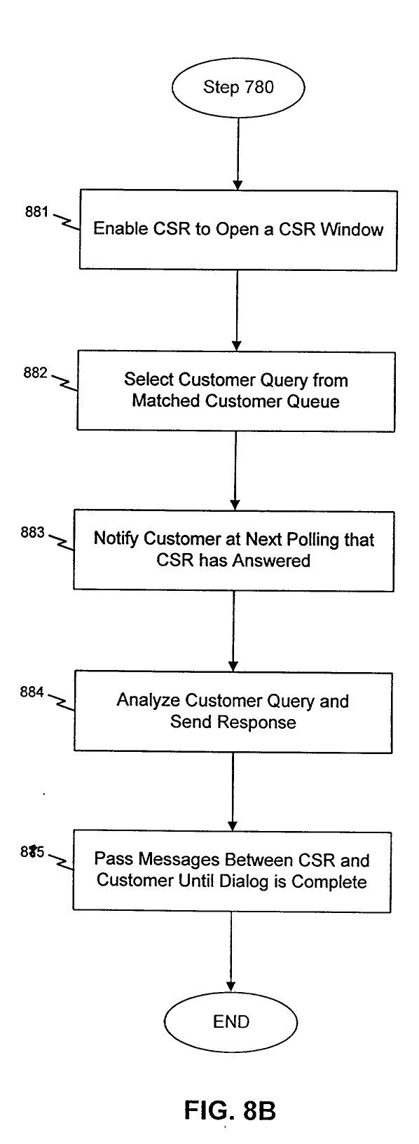

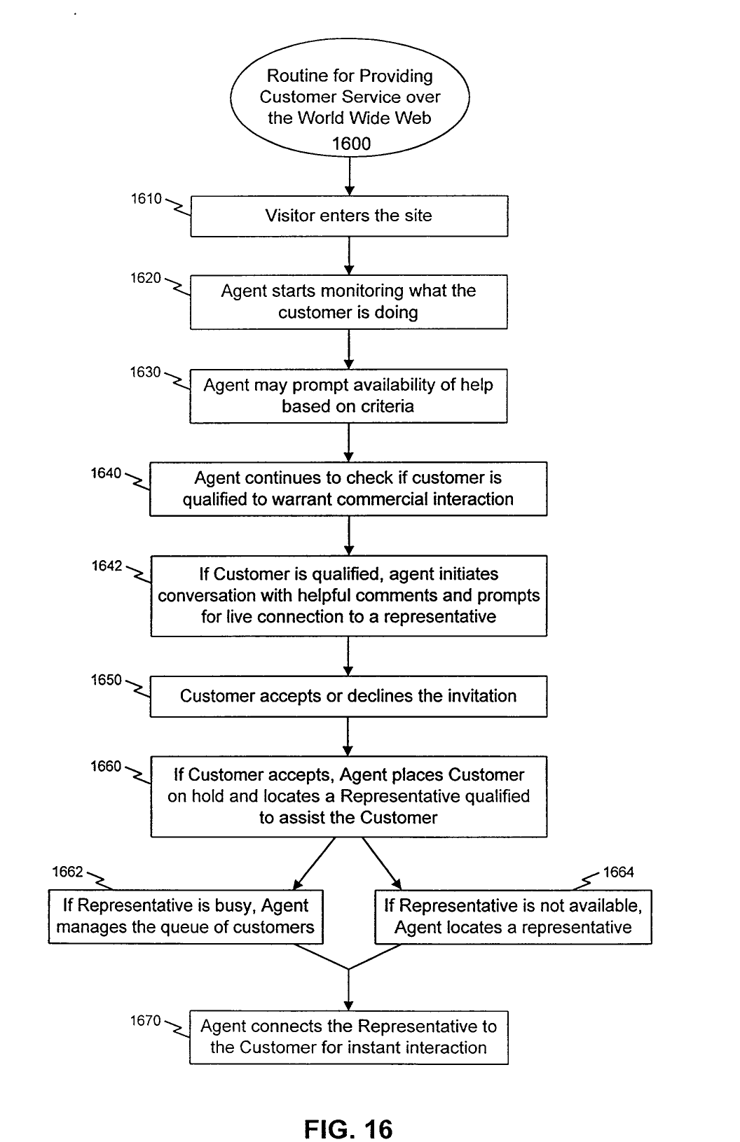

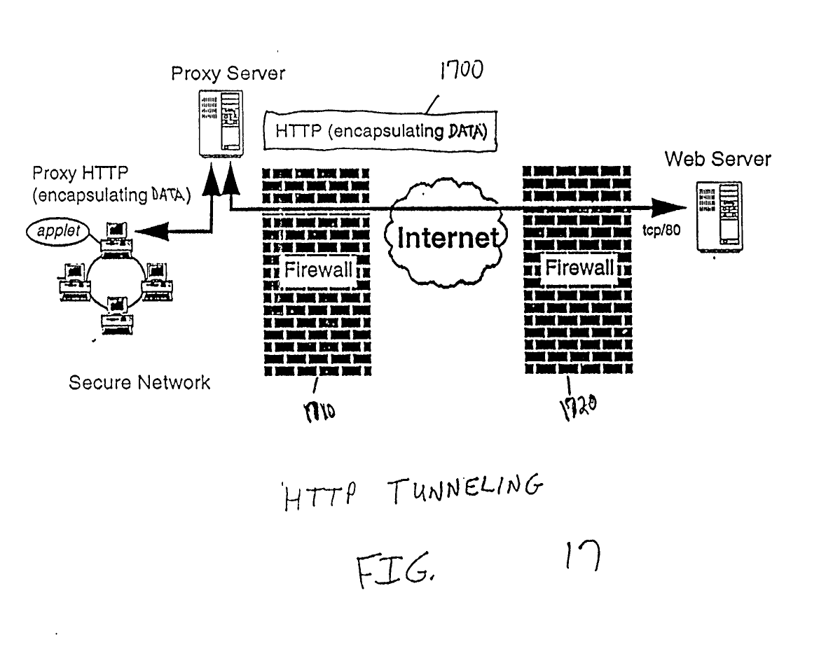

The operation of the present invention in providing live customer service over the Web is described with respect to example architectures shown in FIGS. 5A, 5B, and 6. An example routine 700 for providing live customer service is described with respect to FIGS. 7A-7B and 8A-8B. Another example routine for providing live customer service 1600 is described with respect to FIG. 16.

The present invention can provide different levels of customer service. “Express service” is a level of customer service where a customer query is routed to a CSR primarily on the content of the query. Express service can also include routing based upon profiling and/or monitoring browsing data. “Full” or “Complete” service is a level of customer service where a customer is routed to a CSR based on customer input in query and a service form, profiling, or monitoring of browsing data. Combinations of Express and Full services providing different levels of customer service are also possible. The example of customer service is illustrative only. In general, the present invention can be used in any communication application.

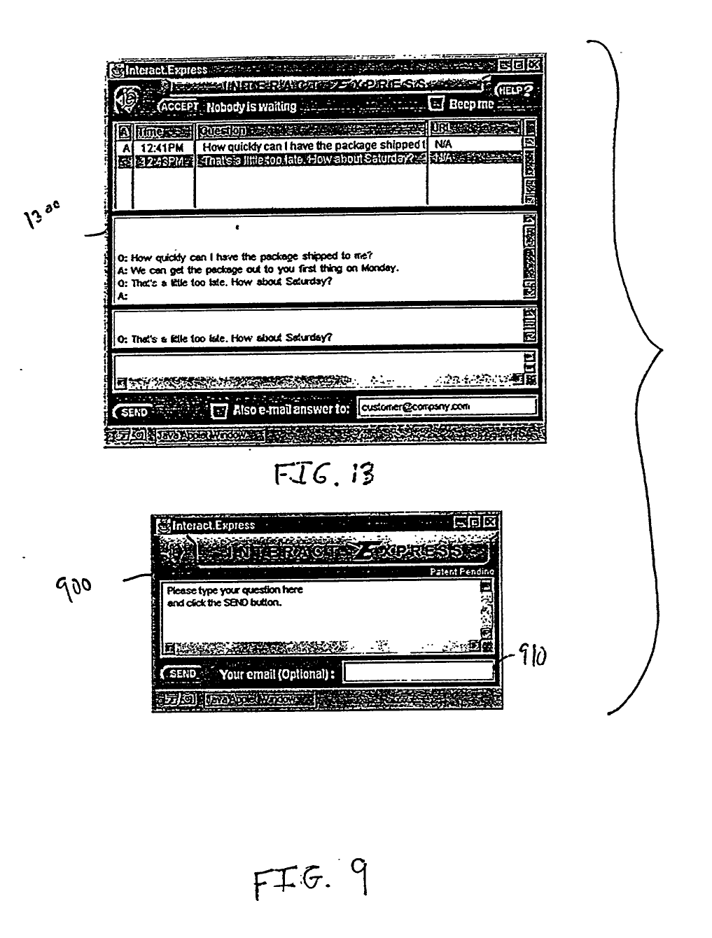

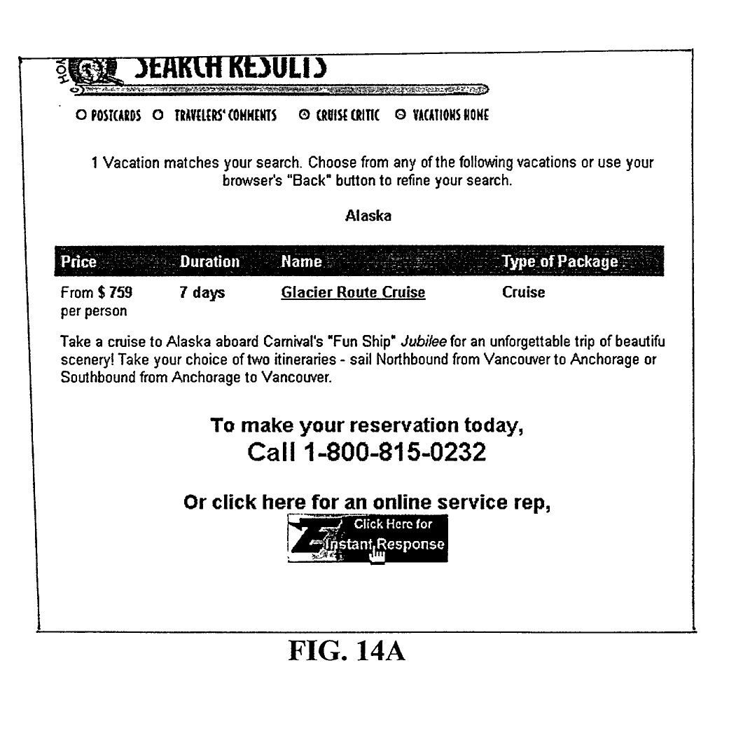

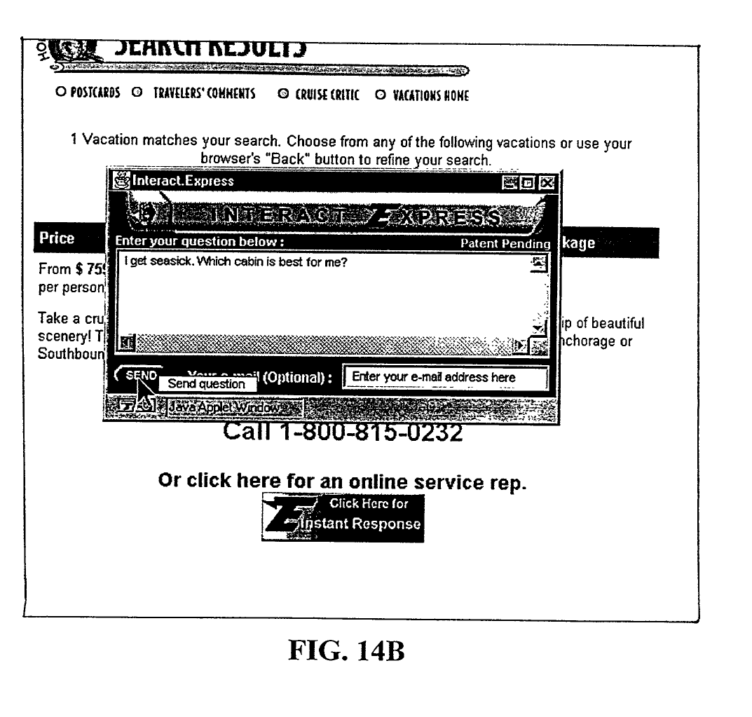

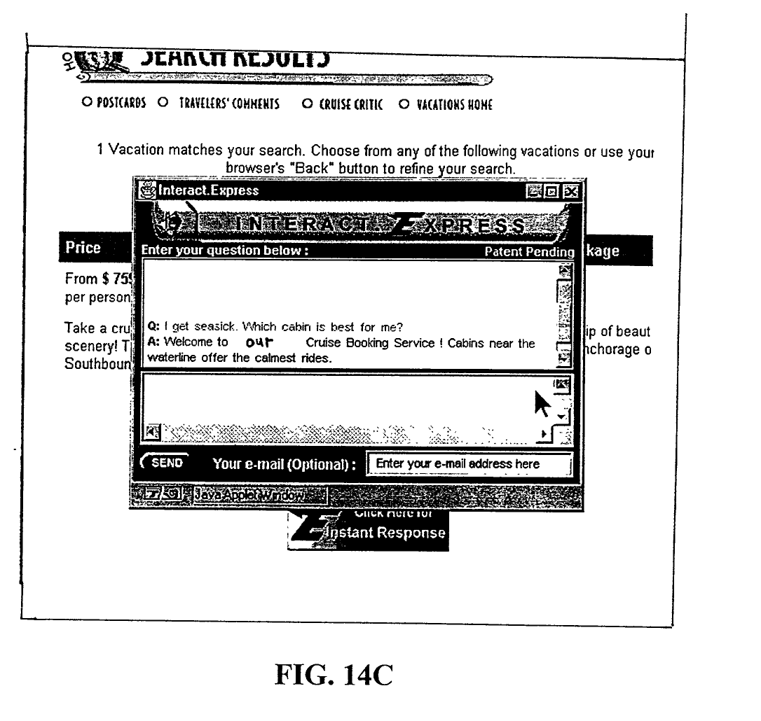

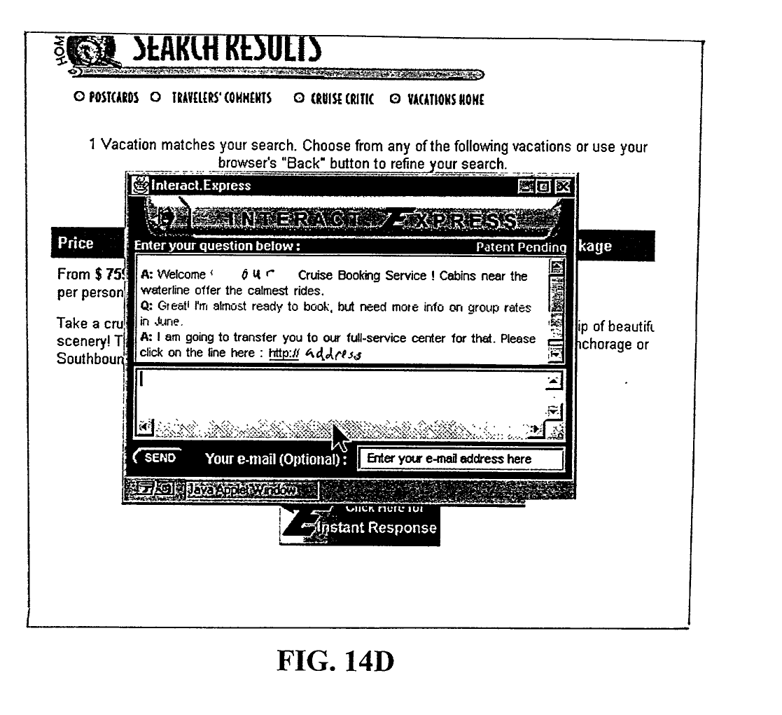

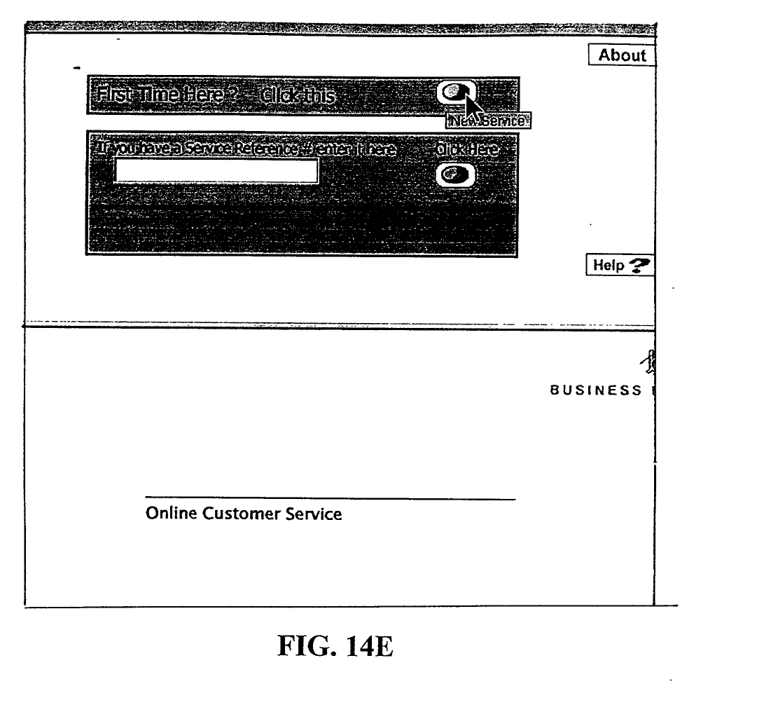

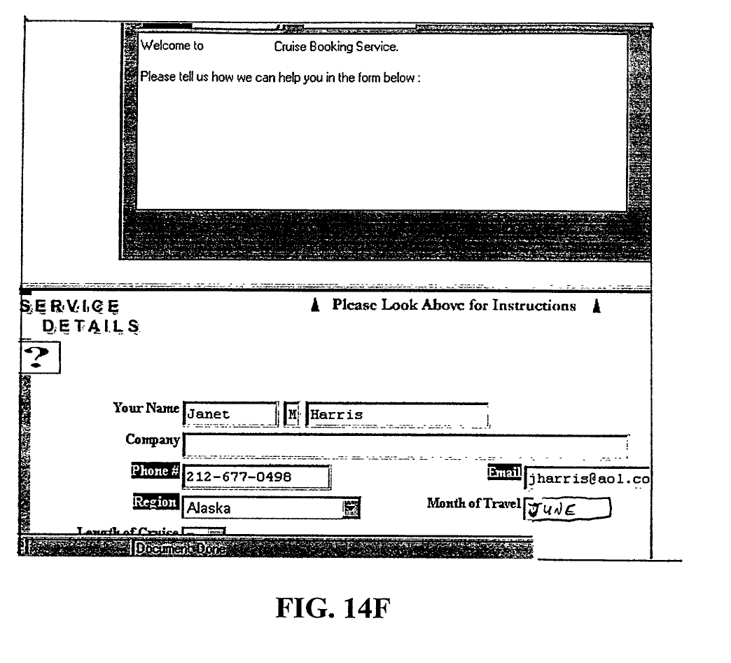

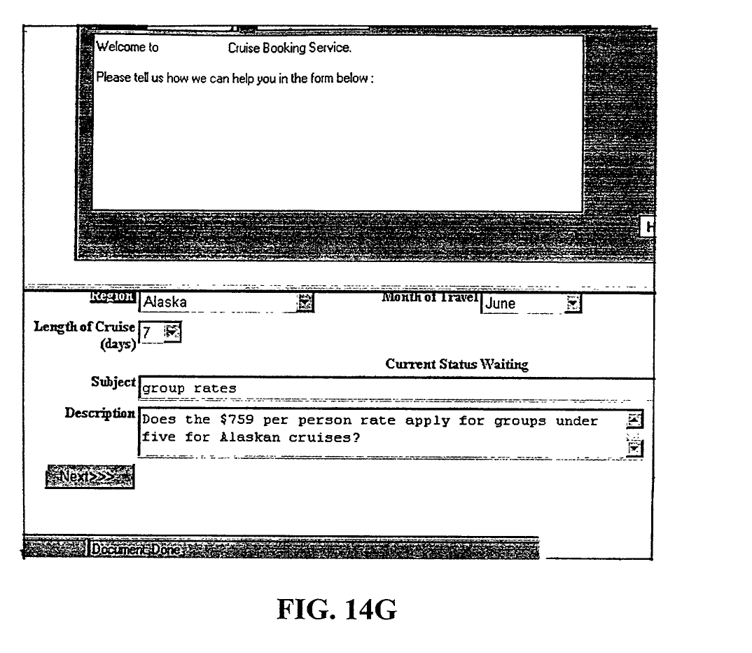

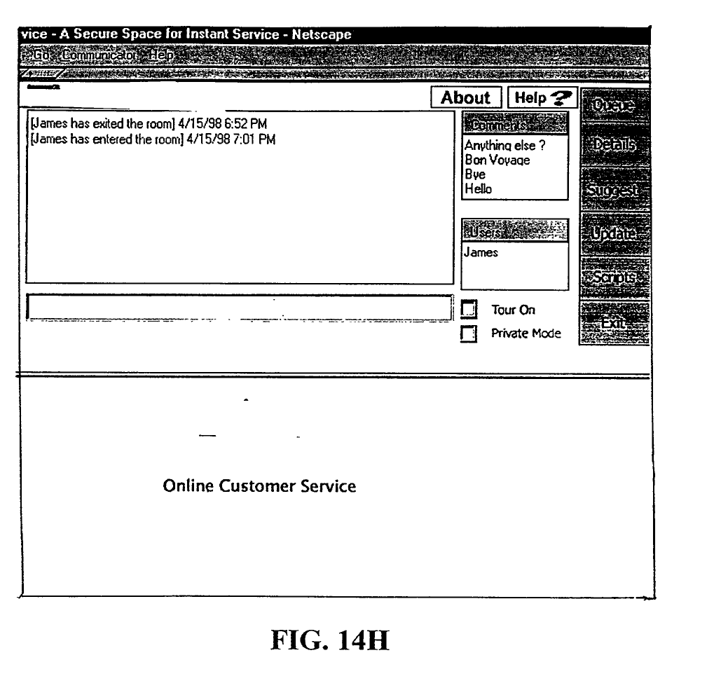

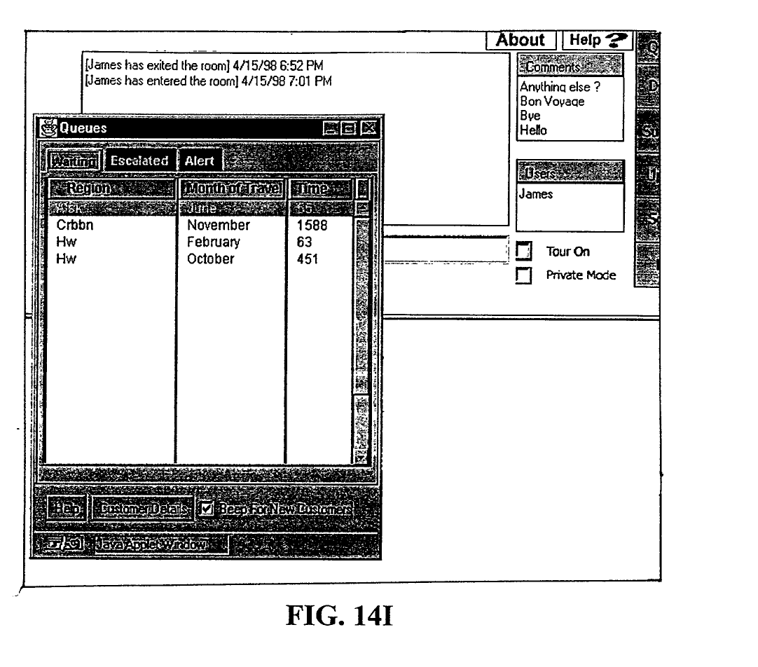

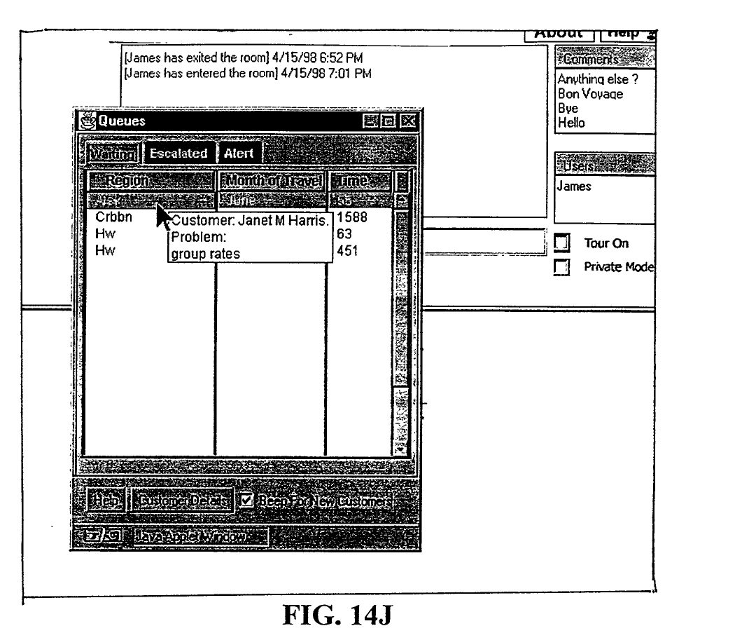

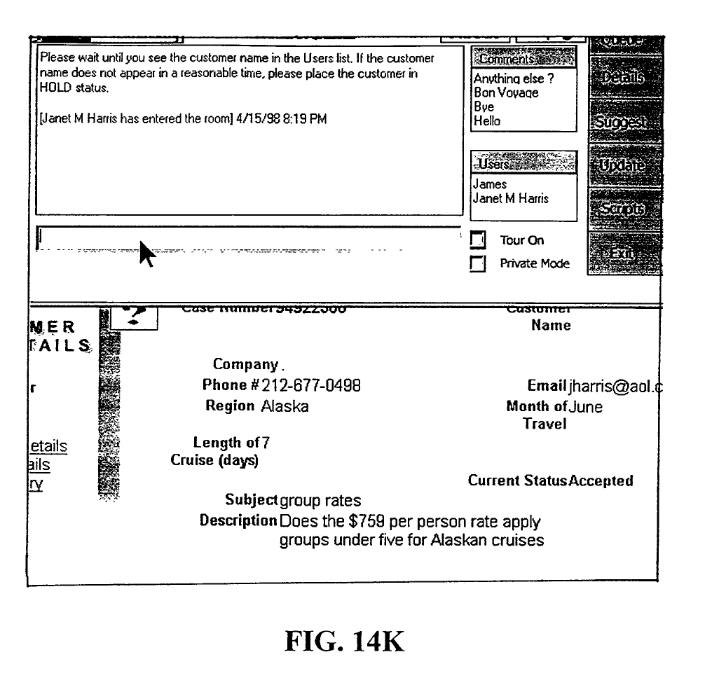

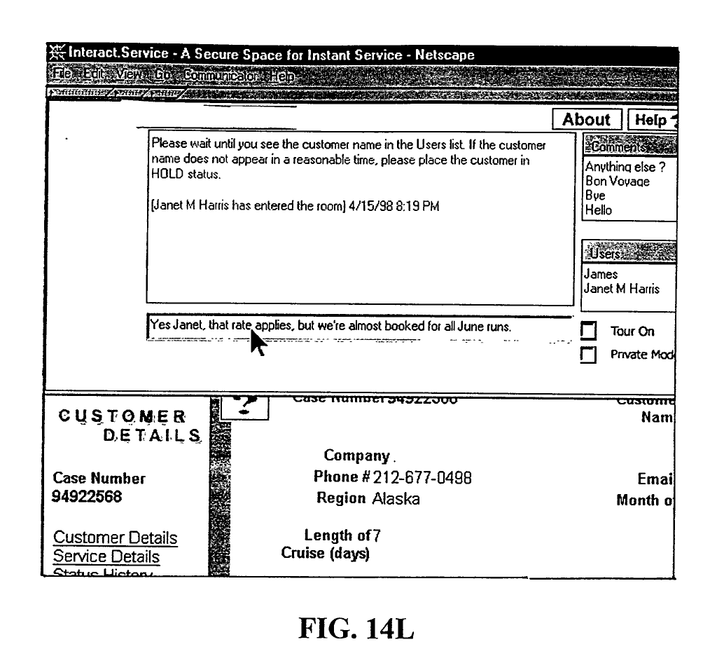

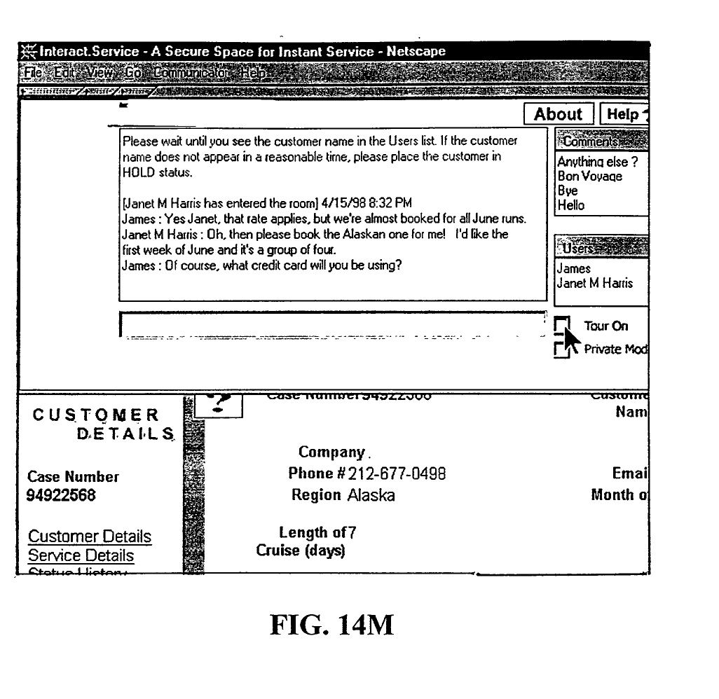

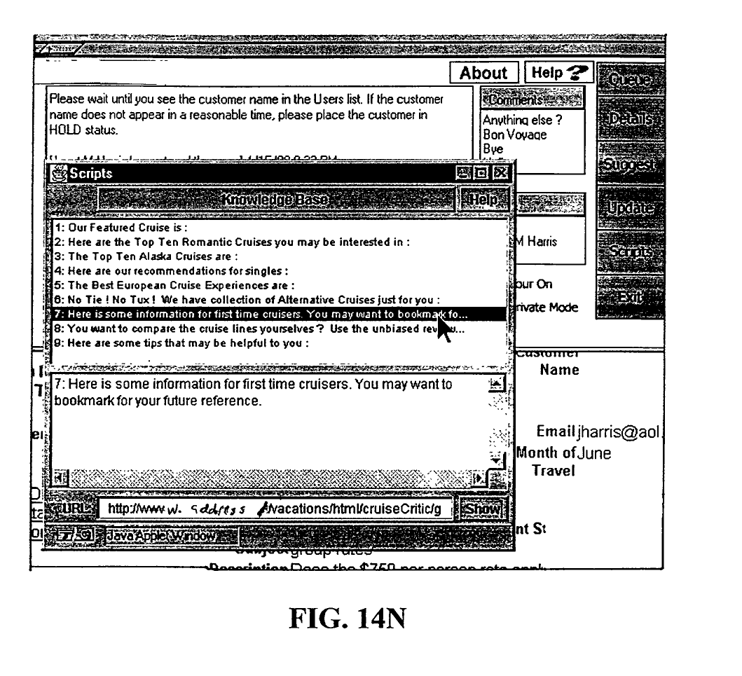

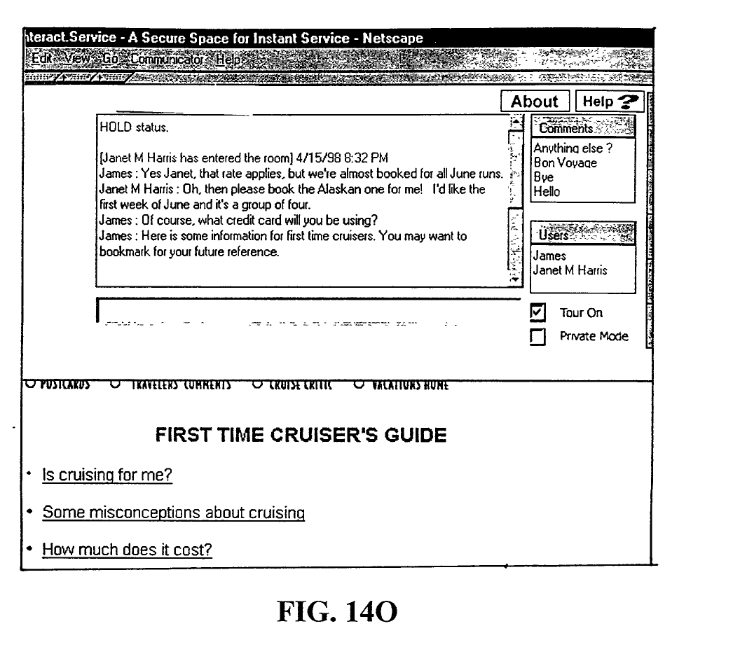

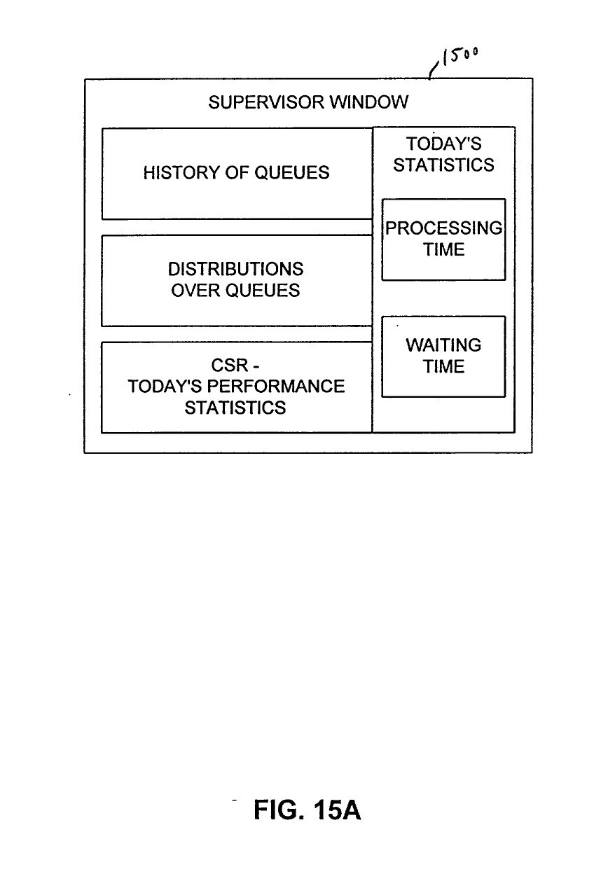

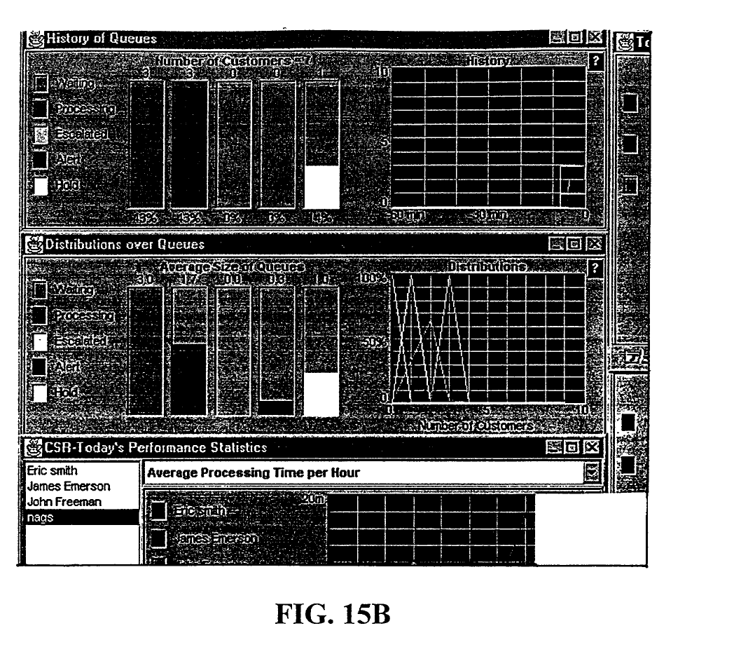

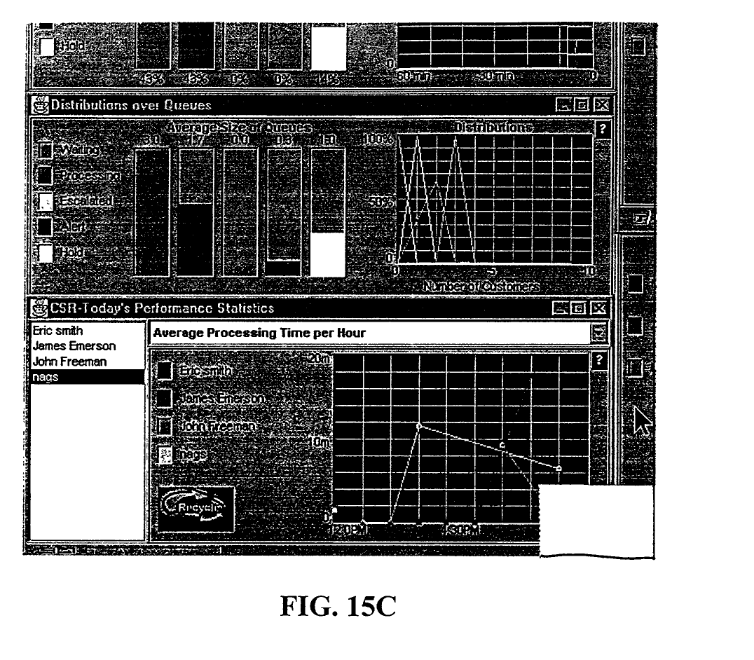

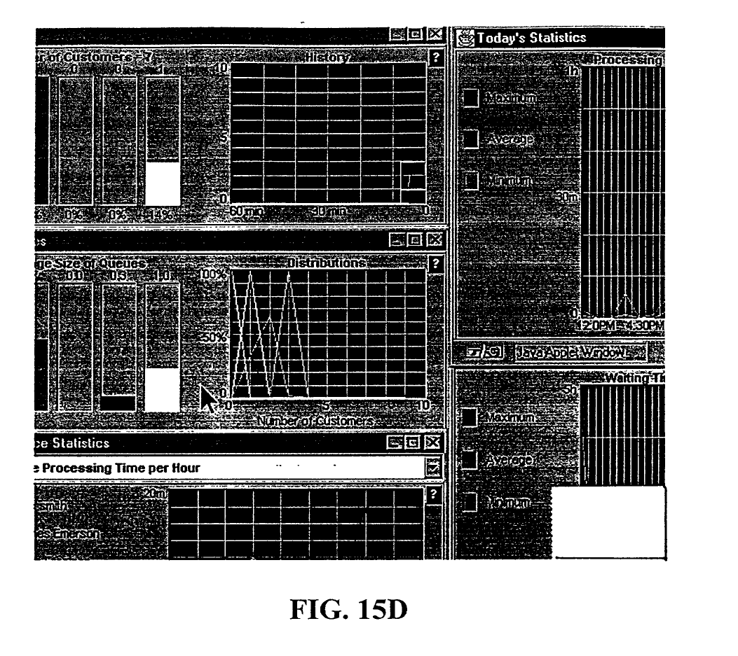

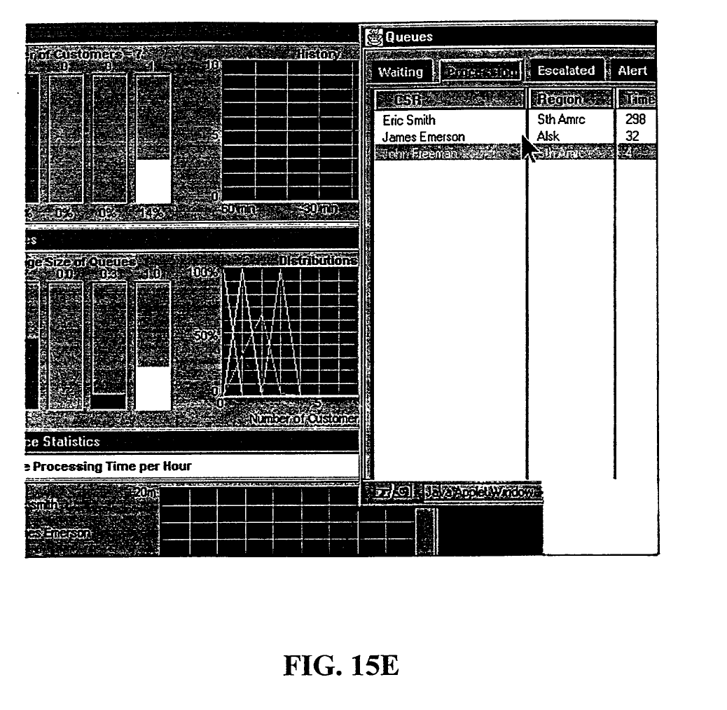

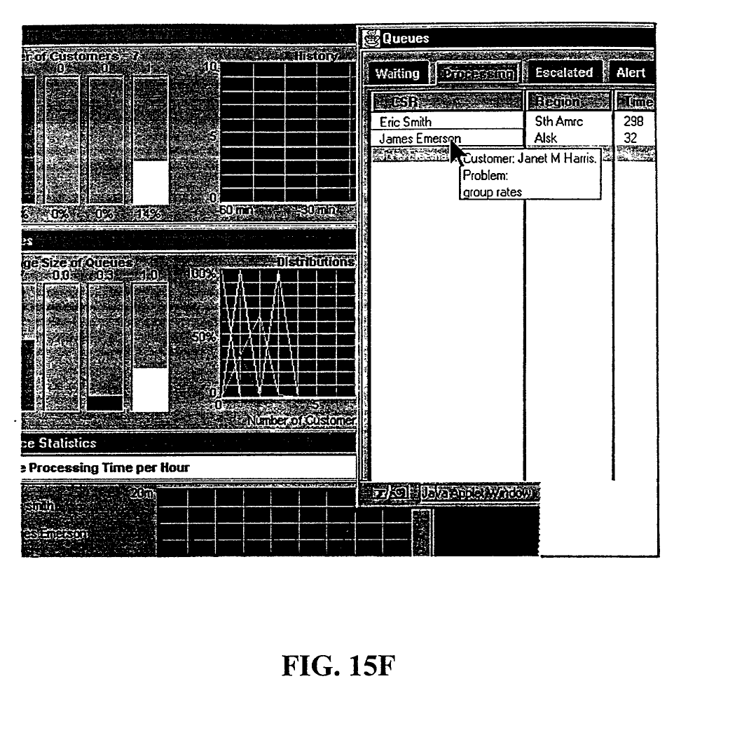

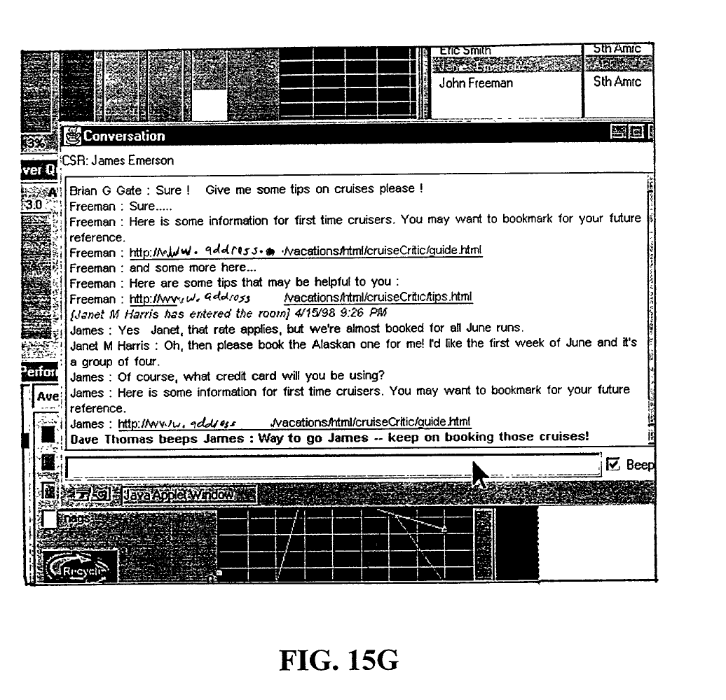

Example screen displays of customer and CS windows used in express service and full customer service center embodiments of the present invention are shown in FIGS. 9-13. A specific example showing the use of the present invention in providing live customer service to support the booking of a cruise reservation is described with respect to FIGS. 14A-14O. An example of a supervisor interface monitoring the live customer service in FIGS. 14A-14O according to the present invention is described with respect to FIGS. 15A-15G.

FIG. 5A is a block diagram showing the components for providing live customer service over the Web according to one embodiment of the present invention. As shown in FIG. 5A, this embodiment includes a Web server 500, customer browser 520, customer service representative (CSR) browser 540, and database 550. Customer browser 520 and customer service representative (CSR) browser 540 can each be coupled to Web server 500 through respective communication links 501, 502 over any network or combination of networks, including but not limited to, the Internet. Database 550 is accessed by customer service agent program 510 and/or CSR browser 540 and can store any type of data or knowledge base related to providing customer service as described further below. FIG. 5A is an example arrangement only. Other arrangements can be used. For example, the CSR and CSR browser 540 can be located at Web server 500.

According to the present invention, Web server 500 includes a customer service center agent 510. Web server 500 also includes a memory 530 for storing data addressed at Web site 532. Web site 532 further includes active content such as, a service applet 534. In this way, Web site 532 is enabled to provide live customer service in coordination with customer service center agent 510. The enabling of the customer browser for service is determined by customer service center agent 510 and service applet 534 as described further below. When service-enabled, customer browser 520 displays a customer service window. Likewise, CSR browser 540 can display a CSR service window. The content of the customer service window and the CSR service window varies under the control of customer service center agent 510 in accordance with the level of customer service being provided.

FIG. 5B shows an example architecture for providing live customer service according to the embodiment of FIG. SA in more detail. Customer service agent 510 is preferably implemented on server 505, which in one embodiment is distinct from the Web server 500. Server 505 is coupled to databases 550 including Oracle, Lotus Notes, DB2, SQL Server, and other Relational Database Managements systems (RDBMS), or non-relational database systems. Server 505 communicates with Mail Gateway 592 and Fax/Pager Gateway 594. Server 505 is also coupled through Web server 500 over the Web to customer browser 520, CSR browser 540, a Supervisor browser 560, and a Site Designer browser 580. Customer service agent 510 performs dialog or call management, service process management, knowledge management and customer interaction in accordance with the type of support. Such support can include either express service and/or a full customer service center as described further below.

As shown in FIG. 6, an example customer service agent 510 includes service manager 610, HTTP communicator 611, matcher 612, and dialog manager 618 coupled to via a bus or network to pending customer queue 613, CSR queue 614, and matched customer queue 616. Other queues (not shown) can be added such as queues for storing customer queries in different stages of processing or different status (i.e., Waiting, Processing, Escalated, Alert, On Hold). Service applet 534 is downloaded to customer browser 520 and executes to provide HTTP communicator 621, service window manager 622, and persistent polling unit 624. CSR browser 540 includes HTTP communicator 641, CSR service window manager 642, and answer search engine 644.

Service window manager 622 manages the content and display of the customer service window on the customer browser 520 as described herein. CSR service window manager 642 manages the content and display of the CSR service window on the CSR browser 540 as described herein.

Persistent polling unit 624 polls the web site after the query is input in the customer service window. The polling allows a customer to be notified while the customer is browsing the Web that a CSR has chosen to respond to the query input by the customer. In this way, a quasi-persistent communication link can be established between a browsing customer and a server (and a CSR) even in a Web environment using HTTP where communication between a browser and a server occurs as a series of discrete temporary connections as described further below.

HTTP communicators 611, 621, and 641 each serve to encapsulate messages being sent over links 500 or 501 into HTTP and to de-encapsulate the encapsulated messages received over links 500 or 501. Such encapsulation and de-encapsulation allows on-line, live customer service according to the present invention to be provided through Internet firewalls or similar or other security devices (including intrusion prevention and detection devices) as described in further detail below with respect to FIG. 17. Customer service agent 510 can automatically detect when a customer is behind a firewall and initiate the use of HTTP encapsulation/de-encapsulation accordingly. Otherwise, if a customer is not behind a firewall, a port-to-port direct communication socket connection can be made in which case HTTP communicators 611 and 621 are not used. Similarly, customer service agent 510 can automatically detect when a CSR is behind a firewall and initiate the use of HTTP encapsulation/de-encapsulation accordingly. Otherwise, if a CSR is not behind a firewall, a port-to-port direct communication socket connection can be made in which case HTTP communicators 621 and 641 are not used.

The operation of any of the architectures shown in FIGS. 5A, 5B and 6 is now described in further detail with reference to the example routine 700 shown in FIGS. 7A-7B and 8A-8B and the example screen displays in FIGS. 9 to 13.

FIGS. 7A and 7B show a routine for providing live customer service 700. First, a customer visits (i.e. surfs to) live CS enabled Web site 532 by inputting a URL (step 705), or via any other surfing technique or mechanism. Web site 532 is enabled by Web server 500 according to the present invention to provide live customer service. For example, Web site 532 can include active content, e.g., a Java applet, that loads in the background of customer browser 520. This active content is also referred to as a “service applet.” In the example of FIG. 6, the service applet 534 loads and runs (or causes to be loaded and executed) HTTP communicator 621, service window manager 622, and persistent polling unit 624 in customer browser 520.

Next, a determination is made on whether the customer qualifies for live service (step 710). The specific criteria used for qualifying a customer for live service can vary depending upon a particular business application and need. For example, only customers having a known status may qualify. In this case, service applet 534 determines customer status and sends the status data to service manager 610. Service applet 534 determines whether a customer status is known, for example, by evaluating whether (i) a customer logged on using a known account number or other forms of identification or whether (ii) data in the computer supporting customer browser 520 exists that verifies that the customer is a known entity (e.g., by reading cookies or data files). Service manager 610 compares the status data obtained from service applet 534 (e.g., account information or cookie data) with service server records in database 550 to determine whether the customer status is sufficient, i.e. whether the customer is known. Any other qualification methodologies can be used. In other embodiments, step 710 is not performed (such that all customers are qualified for live CS).

If the customer does not qualify, the customer may be sent to a first-time user registration form (step 715). A registration form is displayed on the customer browser to allow the customer to enter registration information (name, address, and other data for generating an account or service no.). For example, cookie or magic cookie data can be stored when a customer registers in step 715 or in general visits Web site 532 for the first time.

If the customer qualifies, then service manager 610 enables the customer for live customer service (step 720). What this means is that the service manager 610 will respond if service is requested by the customer browser 520, or will prompt the customer for help if needed. Such a prompt is issued based on browsing data and/or profile data gathered in steps 730 and 740 below. For example, a prompt can issue when the browsing customer has delayed at the Web site or returned back to a Web page or when a high-profile customer has surfed to the site.

In step 730, service applet 534 monitors the browsing activity of the customer and gathers browsing data. For example, service applet 534 can gather browsing data on the browsing actions taken, time spent on each browsing action, length of stay in each Web page, and the URL visited history. As would be apparent to a person skilled in the art given this description, any known technique can be used to read cookie or magic cookie data or other browsing data, and to gather browsing data in step 730. Accordingly, step 730 need not be discussed in further detail. See, e.g., C. Bayers, “The Promise of One to One (A Love Story),” Wired, May 1998 (pp. 130-134 and 184-87) (incorporated by reference herein).

While the customer browses, service manager 610 generates and/or updates a customer profile (step 740). For example, a profile can be determined based on customer information gathered in qualification step 710 (Customer Account record etc.), the area of Web site 532 where customer is currently and other browsing data gathered by service applet 532 so far in step 730, and/or server records. For example, the customer profile can determine whether a customer is a high-margin/low-margin provider, and whether the interaction will be simple or complex.

In step 750, service manager 610 enables a customer service window to opened based on the customer profile. Different types of customer service windows can be used depending upon the customer profile and/or the type of customer service being provided. For example, the customer service window can be a service dialog window and/or a service form. As shown in FIG. 9, a customer service window 900 having a service dialog window can be displayed which allows the customer to input a query or request. The customer service window of FIG. 9 is helpful for an express customer service embodiment where a CSR and customer simply exchange text questions and answers. The customer service window can also be provided with additional fields to allow a customer to add additional information that further optimizes customer service, such as, a field for entering an e-mail address, or a template with fields related to customer service details. Customer service window 900 includes such an e-mail address field 910.

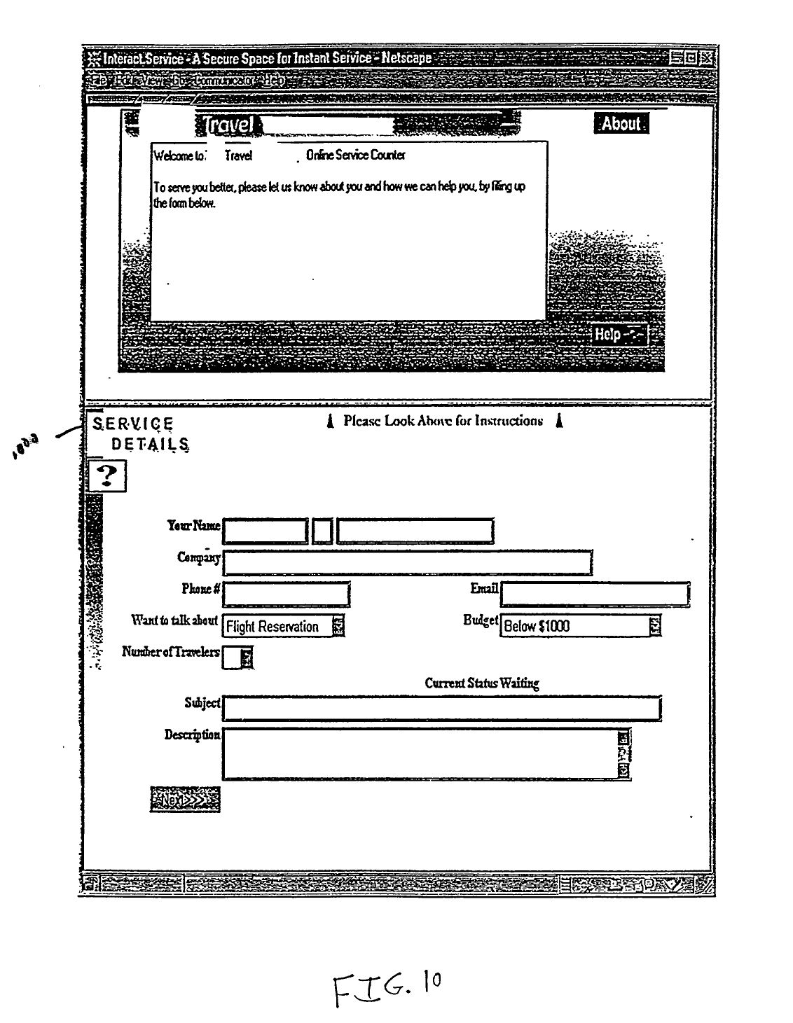

FIG. 10 shows alternative customer service window 1000 having a top half for entering queries or requests and a bottom half-representing a service form for entering additional service details relevant to the Web site content. For example, a travel reservations web site might include relevant information, such as, customer name, company information, what is wanted to talk about, a budget, number of travelers, etc.

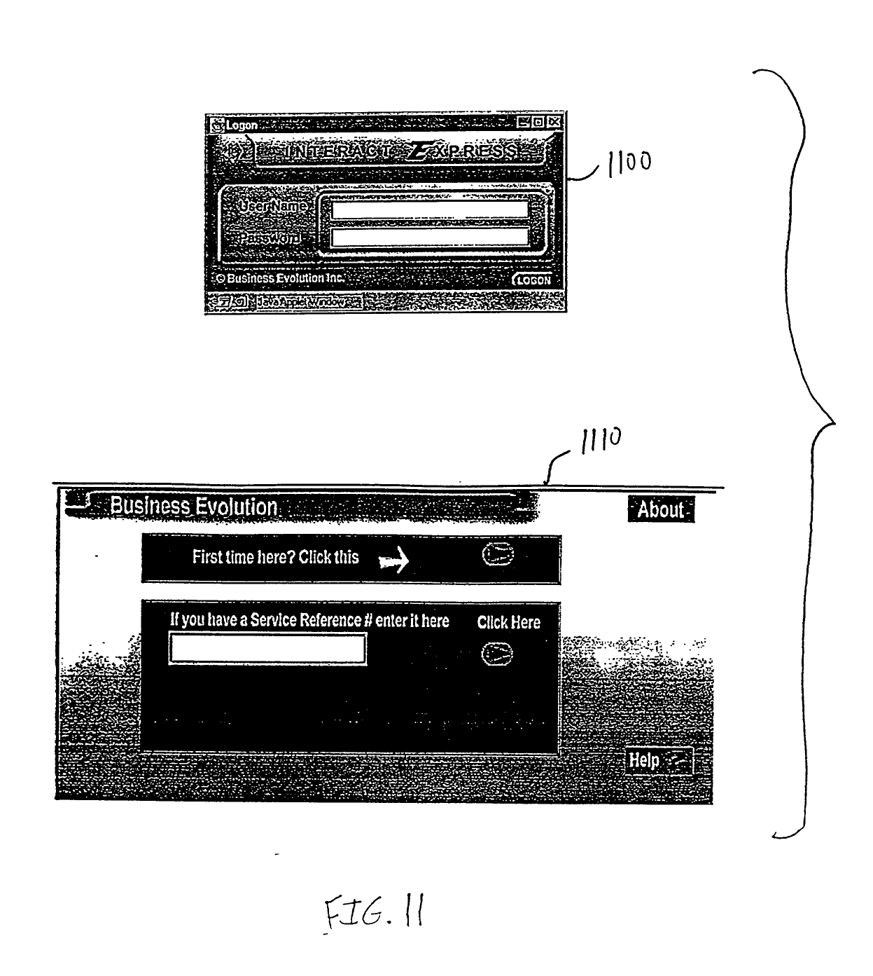

FIG. 11 shows examples of authorization and registration forms which might be initially provided at the customer browser 520. Display 1100 is an authorization form for a user to enter user name and password information. Display 11 10 is a registration form used to allow a first time user to register and to allow previously registered customers to input service reference numbers. In this way, previous customer profile information is quickly retrieved.

The customer service window can also let a customer select the type of customer service wanted. For example, a menu bar or buttons can be added to allow a customer to indicate whether he or she wants a question answered or would like to talk to a CSR. Authorization for the type of customer service a customer can receive can be provided by service manager 610 based upon the browsing data gathered in step 730 and/or the customer profile generated in step 740. In this way, the level of live customer service to be provided can be regulated.

In one example, service manager 610 instructs the service applet 534 (and service window manager 622) whether a customer can enter queries or can request a CSR in a full customer service center. In this way, a company hosting the live CS enabled Web site 532 can regulate customer service according to a policy of the company. For example, higher priority customers or those more likely to be profitable can be given the choice of either entering a query and providing more service information in a service form. For instance, a customer service window for a high profile customer can include a query window and a service form, such as, shown in FIG. 10. Through the service form such customers may be matched directly with a live CSR (i.e. the customers can input the CSR name, if known), or be matched to a CSR based on information in the service form. The service form further allows more complex transactions to be handled more quickly such as electronic payment and purchases, reservations booking, etc.

Lower priority customers can be restricted to the option of entering a query at the outset. New, unknown customers can be provided an express service window such as shown in FIG. 9 where they can only input a query. The query can be routed quickly to a CSR for live customer service. In general, this saves processing at customer service agent 510 as only a query has to be processed. In this way, live CS can be provided to greater numbers of potential customers surfing Web site 532. CSR resources at CSR browser 540 are also saved for more valued customers or complex transactions. Such regulation of service can be important for active web sites which receive thousands of hits per day.

Further, with respect to step 750, a customer service window (such as, but not limited to, the examples discussed above) can be opened when a customer selects service or when service manager 610 instructs the service applet 534 that a customer at customer browser 520 should be offered service or that a customer needs service. For example, a qualified customer can select a “Live CS Help” button that appears on a CS-enabled Web page from Web site 532 when the customer is intrigued or confused and wants further information on a product or service (see button in FIG. 14A). Alternatively, service manager 610 may determine from the browsing data in the customer profile that the customer needs help. In this case, the service manager 610 initiates the opening of the customer service window to invite the customer to interact with a CSR. For example, the service manager 610 may initiate a customer service window at customer browser 520 if a predetermined time period has lapsed or the URL history indicates that the customer is idle at the same Web page. Service manager 610 (or even a CSR) may also determine from the customer profile that the customer is a high priority customer and should be offered help.

As shown in FIG. 7B, a customer enters a query through the open customer service window (step 755). The term “query” broadly refers to any customer input related to customer service, or more generally, any communication of any type. For example, a customer can enter a query either directly within a service dialog window or as part of completing a form. Once a query is entered, customer browser 520 enters into a hold operation, also called EASYHOLD^{SM} operation. During the hold operation, a customer can perform other activities, such as, browsing other Web sites, while waiting for a response to the query or doing other work (step 756). During EASYHOLD^{SM} operation, persistent polling unit 624 at the customer browser 520 periodically (or non-periodically) polls service manager 610 to request a response, i.e., to determine if the service manager 610 holds a response to his or her query. Through service applet 534 the persistent polling unit 624 can operate in the background without interfering with customer browsing.

The query input in step 755 is received by customer service agent 510. Customer service agent 510 at web server 500 then intelligently routes the query to a CSR (step 770). Customer service agent 510 then manages a dialog between the customer at customer browser 520 and the CSR at the CSR browser 540 in preferably synchronized screens (step 780) (although asynchronous screens could be alternatively used) until the dialog is complete (step 785). Customer service then ends (step 790).

Intelligent Routing

FIG. 8A shows an example of step 770. Service manager 610 receives the query input in step 755 by the customer through a customer service window. Service manager 610 stores the query in a queue of pending customer queries 613 (step 872). Queue 613 can store the customer URL or other customer identification and the customer input (e.g., question or form input). CSR queue(s) 614 also store available CSRs.

Matcher 612 matches (or routes) a pending customer query in queue 613 to an appropriate and available CSR listed in queue 614 (step 873). Queue 614 may list any number of available CSRs assigned to handle particular types of queries (e.g. queries related to a particular type of customer, type of subject matter, or region).

In one embodiment, an available CSR first creates and enters a virtual room which can be thought of as service counter. Other CSRs create and work in other virtual rooms. Matcher 612 matches a customer query in express service to the CSR (i.e., to the service counter) which can provide the appropriate level of customer service. In one example, a CSR serves one customer at a time in a virtual room. If the virtual room or service counter is empty, then the customer query is put into the virtual room. Otherwise, the matched customer query waits (e.g., in a matched customer queue 616) until the virtual room becomes available. Of course, other CSRs can enter a virtual room to assist handling customer queries.

For example, one or more CSRs might be assigned to handle European sports cars sales. Each CSR creates and opens its own virtual room or service counter to answer queries. Each CSR is listed in queue 614 along the attributes of the CSR (e.g., these CSR attributes can be field(s) that describe European sports car sales). Matcher 612 then matches a pending query from queue 613 to an available CSR in queue 614 which has criteria similar to the pending query. Matcher 612 may match a European sports car sales query to one available CSR handling European sports car sales in queue 614. Of course, a match need not be exact. A number of variations of matching criteria can be used depending, among other things, upon the level of service to be provided and the types of CSRs which are available. For instance, matcher 612 could match the query to a CSR that handles different queries about European minivan sales or North American sports cars. A CSR can also transfer the query to another CSR to facilitate matching.

Once a match is made, the query is then stored in a matched customer query queue 616 corresponding to the virtual room of the matched CSR (step 874). Matched customer queue 616 can be accessed by the appropriate matched CSR. If the virtual room is empty, then the query is immediately handled by the CSR. Otherwise, the query can wait in matched customer query queue 616 until it is serviced in turn by the CSR. For example, matcher 612 may route the query and service form information to a matched customer queue 616 which is read by a CSR in a virtual room. In the above European sports car example, if matcher 612 matches the query about a European sports car with an available CSR, then the query is routed to matched customer queue 616 (along with other European sports car or related queries from other customers). The available CSR in the virtual room (or other CSRs who enter the room) can look at the contents of matched customer queue 616 to select the next query to answer (see the example of FIGS. 14I and J).

Other examples are described to further illustrate the operation of steps 873 and 874. A query gets matched to a CSR based on a number of factors, such as, but not limited to: content, context, question, and/or qualifications. “Content” relates to the content of a query or service form information. For example, a query can be made at a designer shoe web site that specifies a question about available running shoes and provides service form information such as credit card information or shoe size. Matcher 612 reads the term “running shoes” in the question and any service form information (credit card information or shoe size) and matches the query to a CSR listed in queue 614 having criteria related to running shoes. The running shoe query is then routed to a matched customer queue 616 corresponding to the virtual room of the CSR handling running shoes questions.

“Question” refers to the special case of the content of a question posed in a service dialog window of a customer service window. For example, if a query is made about available running shoes, matcher 612 reads or parses the term “running shoes” in the question and matches the query to CSR which can handle running shoes questions. The running shoe query is then routed to a matched customer queue 616 corresponding to the virtual room of the CSR handling running shoes questions.

“Context” relates to the context of the query or service form information in light of the Web site and page (URL address) at which the query is made. For example, if a query is made about available running shoes at a department store web site displaying a shoe department advertisement, matcher 612 reads the URL address associated with the shoe department and matches the query a CSR handling customer service for the shoe department. The query can be further routed to a matched customer queue 616 serviced by the CSR handling service for the shoe department (or directly to a browser of the CSR handling the shoe department).

“Qualification” relates to status data, browsing data, and/or profiling data that has been gathered as described above with respect to steps 710, 715, 730 and 740. For example, consider three prospective borrowers that surf to a mortgage lender web site and make a query regarding available mortgage rates. The first borrower is a repeat customer with cookie data identifying a high-margin account. Matcher 612 can read the cookie data to identify that the borrower is a repeat visitor with a high net worth and match the borrower to an experienced CSR.

The second borrower is a visitor who has surfed to a URL address related to profitable home sales. Matcher 612 can monitoring the browsing data (URL address for the profitable home sales) and identify that the borrower is interested in a profitable product (home mortgages) and match the borrower to an experienced CSR in home sales.

The third borrower is a visitor who has entered profile information indicating a high net worth. Matcher 612 can read the customer profile and identify that the borrower is a good candidate for a large mortgage and match the borrower to an experienced CSR. If the customer profile indicates that the visitor does not warrant customer service in real-time, matcher 612 can also route the query (and customer identification) for later-time service, such as, an Email response.

These examples and the use of queues 613, 614 and 616 (or other storage device) and virtual room(s) are illustrative and not intended to limit the present invention. Other embodiments can use more queues and rooms (for example when traffic is high and a web site is getting many hits) or fewer or zero queues and rooms (for example when traffic volume is light and transactions are simple). In one example, each matched customer queue 616 is handled by a respective CSR (or a team of qualified CSRs). The invention is scalable in that additional CSRs, queues (pending customer queries queues 613, CSR queues 614, and matched customer queues 616), and virtual rooms, can be added to maintain continuous real-time response during service hours and to handle increases in service volume, that is, to handle a greater number of service requests and queries. Queries pending in matched customer queue 616 can also be ranked or prioritized based upon context, criticality, and/or question content. This way a CSR can readily select from a display in the CSR window the next most urgent query to answer.

Also, queues 613, 614 and 616 and a virtual room are optional. For example, if traffic volume is light or if only one CSR is handling a service area, pending customer queue 613, CSR queue 614, and/or matched customer queue 616 and the corresponding virtual room may be unnecessary. In that case, a query can be routed directly to a browser of the appropriate CSR.

Dialog Management

Once a match is made (step 770), service manager 610 passes control to dialog manager 618 (step 875). Dialog manager 618 then manages the dialog between customer browser 520 and CSR 540 (step 780) until the dialog is complete (step 790). FIG. 8B shows an example of step 780. The CSR is enabled to open a CSR Window (step 881). For example, the CSR can visit Web server 500 and download a CSR service applet (not shown) that loads and runs (or causes to load and run) CSR window manager 642, answer search engine 644, and HTTP communicator 641 in the CSR browser 540. CSR window manager 642 executes to display a CSR window including a display of the contents of matched customer queue 616.

CSR selects a customer query in the matched customer queue 616 (step 882). CSR browser 540 then notifies dialog manager 618 that the CSR has selected the matched customer query. Dialog manager 618 receives the notification that the CSR has begun work on the query and sets a flag or other identifier to indicate that the pending customer query in matched customer queue 616 has been selected by a CSR. Because the HTTP connections between the customer browser 520 and web server 500 are likely closed (i.e. the customer is browsing other sites or performing other tasks), dialog manager 618 does not send a notification to the customer browser 520 until the persistent polling unit 624 at customer browser 520 next polls to check whether a response has been received. The delay in sending a notification to the customer browser 520 depends among other things upon the frequency of the persistent polling and can be minimal (i.e. less than a second or so to maintain real-time interaction with the customer at customer browser 520). See the persistent polling described further below.

Dialog manager 618 then notifies the customer at the next polling by the persistent polling unit 624 (step 883). For instance, the customer can be alerted with an audio and/or visual indication, such as, a “Beep” sound or a flashing. In this way, the customer is notified when a CSR has picked up a customer query regardless of which Web site the customer has moved onto during the period of EASYHOLD^{SM} browsing.

The CSR then analyzes the customer query and formulates a response (step 884). Any CSR response is sent to the customer through dialog manager 618 until the dialog is complete (step 885). Upon completion of interaction, CSR bids good bye if the customer is satisfied with interaction, or may escalate the level of service if the dialog needs to be transferred to another operator. CSR may also put the Customer on hold, or recommend a solution so that customer may come back for another interaction without any interruption. When the transaction is complete, the CSR may E-mail a transcript to the customer, and/or update the database 550 (i.e., update account information and update service history including recording questions asked and answered). Alternatively, customer service agent 510 can automatically E-mail a transcript to the customer, and/or update the database at the end of a service call to minimize the burden on a CSR.

The CSR is aided in selecting a customer query in step 882 and in formulating an appropriate response in step 884 by tools and information provided in the CSR window. In particular, when the CSR picks up a customer query, he or she can be presented with information related to the customer and the customer query, such as, the customer's name, URL, URL history, form data, a current query, past queries by the same customer, browsing data, legacy data (account information and purchasing habits), service history and any other data in the matched customer queue 616, the customer profile generated in step 740, and database 550.

Further, the CSR window allows a CSR to access recommended answers relevant to the customer query. Answer search engine 644 parses the customer query and isolates key terms. Answer search engine 644 then generates a list of recommended answers stored in a knowledge base which are associated with these key terms. The CSR can then select one or more of these answers and send to the customer in response to his/her query. Thereby, achieving a number of advantages, such as, efficiency, throughput, consistency of advice, etc.

A CSR can also select information to provide the customer from prestored scripts. These scripts can contain information (data files and other URLs) relevant to many queries and answers. A list of common answers or comments can also be provided separately, or as scripts or recommended answers. In this way, through the CSR window, a CSR can quickly provide informative answers to the customer. A CSR can easily push pre-stored information including data files and URLs to help the customer. CSR can directly input a reply to a query and/or can enter into a 1-1 dialog with the customer. An answer search engine 644 can also be run to generate a list of possible answers based on the query content or other input from the CSR.

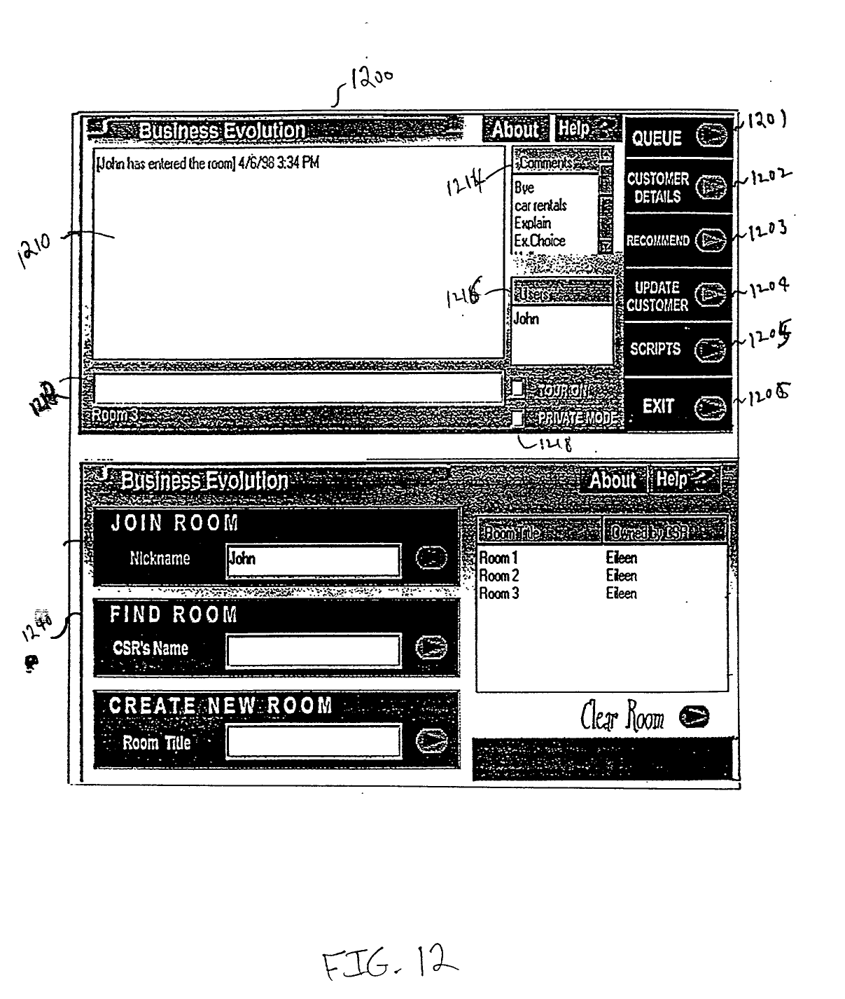

FIG. 12 shows an example CSR window 1200. CSR window includes a menu bar having a Queue button 1201, Customer Details button 1202, Recommend button 1203, Update Customer button 1204, Scripts button 1205, and an Exit button 1205. As described above, pressing Queue button 1201 displays the contents of matched customer queue 616. Pressing Customer Details button 1202 displays further customer profile information. Pressing Recommend button 1203 displays a list of recommended answers either pre-stored answers or answers generated dynamically by Answer Search Engine 644 based on a particular query or CSR input. Pressing Update Customer button 1204 updates customer profile information. Pressing Scripts button 1205 displays a list of available scripts. Exit button 1205 can be pressed to exit CSR window 1200.

CSR window 1200 further includes a main window 1210 for displaying, among other things, status information for a dialog and the contents of messages (queries and responses) passed between the CSR and customer during a dialog. A response from the CSR can be input into input window 1212. The CSR can select a comment to be included as part of a response from a list of comments in a Comments window 1214. A list of active users in a service room (the CSRs) appears in a Users window 1216.

A bottom portion 1220 of the CSR window 1200 includes a window that lists each active “virtual” service room and the name of a CSR who owns the service room. Other windows are provided that allow a CSR to join a room, find a room, or create a new room. Each room holds the one or more active CSRs which are handling a respective matched customer queue 616. Matcher 612 picks an available CSR (or in other words an available virtual room) to match to a query as described earlier. According to a further advantage of the invention, matcher 612 can further distribute queries across virtual rooms. In this way, matcher 612 not only matches queries to qualified CSRs but also helps to distribute queries to ensure a real-time, interactive customer service response is maintained.

CSRs can also move to between rooms to handle backlogged queries independent of the work of matcher 612. In other words, CSRs can enter more than one room. This allows a CSR to multiplex time spent on work routed from matcher 612 to the CSR and any outstanding work the matcher 612 may have routed to other CSRs. For example, a CSR can move and select from pending queries in the matched customer queue 616 (which matcher 612 matched to that CSR) and other queues in which the CSR may decide to serve (independent of matcher 612). This helpful when the CSR is experiencing a lull period. Such lulls can occur, for example, when the CSR has answered all pending queries to which it is matched or if the CSR is waiting for further input from a customer. The CSR can then move temporarily to handle other queries in another room (that is other queries that matcher 612 has routed to other matched customer queues being handled by other CSRs). For example, a European sports car CSR might enter a virtual room where CSRs are handling North American sports cars queries. The European sports car CSR can further scroll pending queries (and read pop-up balloons as shown in example FIG. 14J) to select one he or she can answer effectively.

FIG. 13 shows an example CSR window 1300 used for an express customer service embodiment where a CSR and customer simply exchange text questions and answers. CSR window 1300 only includes a field for a CSR to type an answer. Alternative embodiments are possible as CSR window 1300 could also include a menu bar and/or a window for managing service rooms as in FIG. 12 described above.

Persistent Polling

Typically, the HyperText Transport Protocol closes a connection between a browser and a server after a message is sent or received. To restore the HTTP connection, a browser must re-initiate contact with the server, that is, return to the same URL address of the server. Thus, to maintain a persistent link, a browser must generally remain at a given URL address of a server.

As recognized by the inventor, such a restriction can be detrimental to effective customer service over the Web. It is desirable that a browsing customer be able to make a request for customer service and still have the freedom to roam a vendor's site or other area interest. It is further desirable that a CSR be able to prompt the customer rather than having to rely upon a customer to take the initiative and return to a web site.

Thus, according to a further feature, persistent polling unit 624 polls the web site after the query is input in the customer service window. The polling allows a customer to be notified while the customer is browsing the Web that a CSR has chosen to respond to the query input by the customer. In this way, a quasi-persistent communication link can be established between browsing customer 520 and server 500 (and CSR 540) even in a Web environment using HTTP where communication between a browser and a server is limited to a series of discrete temporary connections. By “quasi-persistent” link, we mean a link which is made as result of polling according to the present invention.

Through Firewalls: HTTP Encapsulation

FIG. 17 illustrates an example of HTTP tunneling whereby encapsulated data can be passed in HTTP messages 1700 through firewalls over the Internet (and/or intranet). In particular, each HTTP communicator 611, 621, and 641 encapsulates data to be sent into a text message tagged and marked according to the HTTP protocol. Each HTTP communicator 611, 621, and 641 further deencapsulates messages which are received. The messages are stripped of HTTP protocol tags and fields to extract the encapsulated data.

In this way, on-line, live customer service can be provided to a wide community of customers including customers connected to the Internet through a firewall. FIG. 17 shows two Internet firewalls 1710 and 1720 which pass data encapsulated in a HTTP protocol message 1700. Such firewalls are set up to allow HTTP traffic to pass through TCP/80 port between a Web server and a proxy server. See, R. McGregor et al., Java Network Security, IBM Machines Corp. 1998, chapter 11 “Firewalls; In and Out of the Net”, pp. 169-194.

Security

Because the invention can operate at an application layer using or compatible with HTTP, secure customer service over the Web can be provided using Web-based security techniques or devices that are known now or are developed in the future. In one preferred example, security for each of the communications over links 500 and 501 described above according to the present invention is provided through a secure socket layer (SSL). The secure socket layer is a widely used protocol for implementing cryptography in the Web. SSL can be invoked from within Java and is supported by current browsers (e.g., SSL v3.0 is implemented in Netscape 3.0 and higher and Microsoft Internet Explorer 3.0 and higher), as would be apparent to a person skilled in the art given this description. See, R. McGregor, chapter 12 “Java and SSL”, pp. 195-199 and SSL protocol at http://home.netscape.com/newsref/std/SSL.html (each of which is incorporated by reference in its entirety herein). A secure protocol, such as, secure HTTP (S-HTTP), can also be used. See, L. Stein, at 36-47 (incorporated in its entirety herein by reference). In general, other compatible encryption protocols and security techniques can be used in addition to or instead of SSL and S-HTTP.

Example of Live Customer Service Supporting On-Line Travel Reservations

The practical advantages of the present invention in providing live customer service over the Web become even more evident in considering a common example in Web commerce: booking on-line travel reservations. As mentioned above, the Web has created a real-time information infrastructure. Today, consumers receive immediate responses to most of their electronic interactions. However, this infrastructure lacks a real-time customer support mechanism to go along with it. Instead of live customer service, on-line consumers must use e-mail links that take hours or even days to get a response from, and telephone numbers that require a person to turn off their Internet connection and use a phone line. This is especially problematic in the booking of on-line travel reservations where it is desirable that the context of a Web site not be lost and that an electronic transaction be tailored to meet an individual's own tastes and needs.

The present invention provides away of channeling customer service live, in real time, over the WWW. Implications of using live customer service at a travel site are tremendous. For most ticketing, especially for vacations and cruises, consumers need personal consultation before going through such expensive and complicated purchases. Consumers can enter basic preferences today, such as price range, length of trip, and the destinations they'd like to go to. They can self-serve themselves by entering this information, but nearly everyone has many specific questions, and they want immediate answers.

As mentioned above the present invention can include but is not limited to, an Express Service and a Full Customer Service Center. For travel reservations in this example, a visitor is first provided with express service to allow a CSR to answer questions efficiently and in real-time (FIGS. 14A-14D). The customer is then transferred to a Full Customer Service Center to handle more complex booking and reservations (FIGS. 14E-14O).

For example, as shown in FIG. 14A, a Web site for making travel reservations when enabled for live customer service according to the present invention includes a button for selecting an instant response. A first-time customer named Janet who browses the site and selects the button is presented with an Express Service Window. Janet can then input her query: “I get seasick. Which cabins are best for me?”; and press a send button (FIG. 14B). Janet can continue browsing until a response from a CSR arrives.

Janet's query is intelligently routed to a matched customer queue. For example, the query can be routed to a queue related to cruises. In this way, CSRs responsible for cruises and knowledgeable about cruise information can respond. Through a CSR window, a CSR opens the queue of pending queries including Janet's query. The CSR returns a response: “Welcome to our Cruise Booking Service! Cabins near the water-line offer the calmest rides.” (See FIG. 14C). In this way, Janet receives a quick, personalized answer to her question instead of scrolling through a Frequently Asked Questions (FAQ) list, placing a separate phone call, entering a non-private chat room, or waiting hours or even days for an e-mailed response.

Janet and the CSR can continue to exchange messages. For example, Janet may respond, “Great! I'm almost ready to book, but I need more info on group rates.” Answering this question is a more complex transaction and requires detailed customer information. Accordingly, the CSR may suggest a transfer to a Full Customer Service Center to allow more detailed input and service beyond instant messaging. For example, the CSR can send Janet a URL to transfer Janet to the Booking Service (see FIG. 14D).

When Janet visits the Booking Service URL, a service applet opens a registration form Service window on her computer in which a service reference no. or in which a first-time user can be identified and registered (FIG. 14E). Once Janet has registered, a service window is displayed which includes a dialog window and a form (FIG. 14F). Janet can scroll through the form and input a few personal details, such as, name, company name, phone number, e-mail address, region, month of travel, length of cruise, subject of question, and description of question or problem (FIGS. 14F and 14G). Thus, Janet can ask her more complicated questions. “Does the $7,659-per-person rate apply for groups under five, for Alaskan cruises?” (FIG. 14G). Once Janet sends her information, a message can be sent to her automatically informing her that “The Service Rep. is ready to serve you. Please wait until you see the first message from the Service Representative.”

A CSR named James enters a virtual room and views a CSR window (FIG. 14H) and opens a Queues window that displays information on waiting customers (FIG. 141). For example, the Queues windows can display information for region, month of travel, and time fields for different types of active customer status, Waiting, Escalated, Alert (FIG. 14I). James can select a particular customer he is considering handling. A balloon opens providing even more customer information, such as, the customer name and subject fields (FIG. 14J).

James selects the customer and inputs a response (FIGS. 14K and 14L). To determine an appropriate response, among other things, James can select any option within the CSR window. James can select from a menu bar to view the customer profile, view recommend answers generated by a answer search engine based on the fields information input by Janet, update customer profile, select a script, and/or exit. James can also select a prestored comment to further build a desired message (FIG. 14K). James inputs response: “Yes, Janet, that rate applies. But we're almost booked for all June runs.” (FIG. 14L).

Janet inputs that she wants to go ahead and book the cruise. James requests credit card information from Janet. (FIG. 1 4M). This is an advantage of a secure link.

James can also select a script from a listing of scripts available in a knowledge database (FIG. 14N). This listing can be automatically pruned further so that James sees scripts which match the field information provided by Janet (i.e. cruises, Alaskan). James then pushes a script on pertinent cruise information for a first-time cruiser he selected.

FIG. 14O shows the customer service window seen by Janet which includes the message display history in the upper dialog window and the script, “First Time Cruiser's Guide” sent by James in the lower window. In a few more exchanges with James, Janet can complete the entire transaction. James can then push Janet a receipt and a detailed itinerary of the trip, just as if Janet were at a travel agency.

As mentioned with respect to FIG. 5B, a supervisor can also monitor many CSRs simultaneously through his or her own supervisor browser and supervisor agent 560. FIGS. 15A-15G show an example Supervisor Interface 1500 displaying different tracking functions for CSR activity in different subwindows: History of Queues; Distribution Over Queues; CSR Performance; and Today's Statistics (FIG. 15A). As shown in FIG. 15B, History of Open Queues subwindow displays the number of customers in a queue and their service status: waiting, being processed, escalated in service, on alert, or on hold. A history of the time customers have spent in a respective status is plotted in a line graph. Distribution Over Queues subwindow displays the average size of queues (i.e. the number of customers) for each service status: waiting, being processed, escalated in service, on alert, or on hold. A distribution of the number of customers for each respective service status is plotted in a line graph.

As shown in FIG. 15C, CSR Today's Performance subwindow lists each CSR by name. A line graph shows the average customer processing time per hour each CSR has achieved. The CSR Today's Performance subwindow further includes a pull-down menu that allows a supervisor to select to display information on the Average Processing Time Per Hour (shown in FIG. 15C), or information on the number of customers completed, accepted, recommended, escalated, or alerted (not shown). As shown in FIG. 15D, a Today's Statistics subwindow includes graphs on processing time and waiting time.

A supervisor can display a queue being serviced (FIG. 15E), and select a CSR to monitor his or her actions (FIG. 15F). For example, a supervisor can monitor the conversation between James and Janet, and speak to the CSR if necessary. As shown in FIG. 15G, the supervisor can open a Conversations Window and input a message: “Way to go, James! Keep on booking those cruises!”

Example Computer Implementation of Invention

The subject invention has been described above with the aid of functional building blocks illustrating the performance of specified functions and relationships thereof. The boundaries of these functional building blocks have been defined partly for the convenience of the description. Alternate boundaries may be defined so long as the specified functions and relationships thereof are appropriately performed. Any such alternate boundaries are thus within the scope and spirit of the claimed invention. These functional building blocks may be implemented by discrete components, application specific integrated circuits, processors executing appropriate software, and the like or any combination thereof. It is well within the scope of a person with ordinary skill in the art to develop the appropriate circuitry and/or software to implement these functional building blocks.

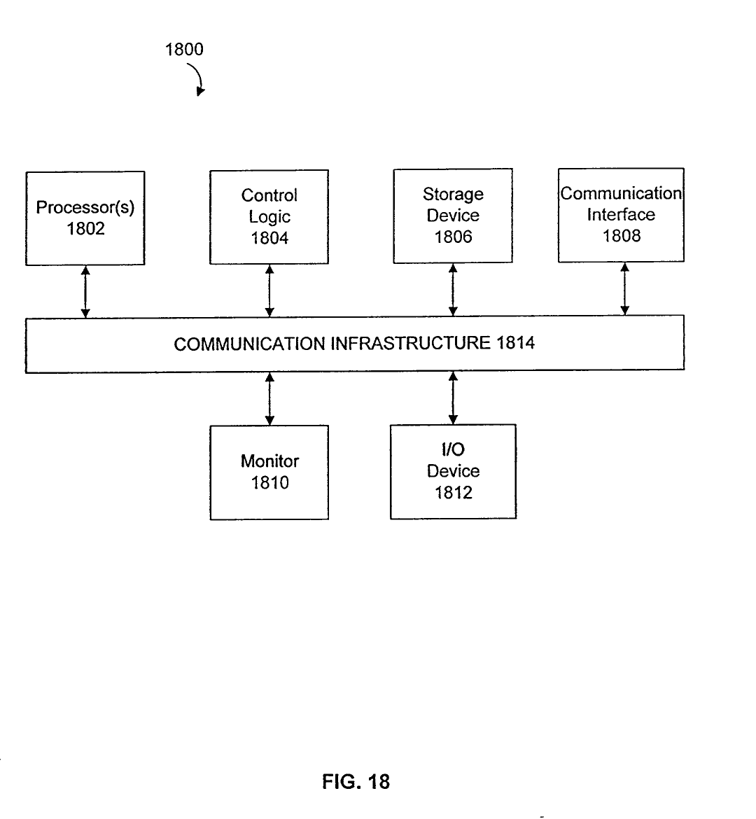

In particular, each of the components: web server 500, customer service agent 510, browser 520, and browser 540 can be implemented as software executing on its own respective processor or multi-processor computer system. An example computer system 1800 is shown in FIG. 18. The computer system 1800 includes one or more processors 1802, control logic 1804, storage device 1806, and communication interface 1808. A monitor 1810 and other input/output (I/O) devices 1812, such as, a keyboard, touch screen, mouse, printer, and/or speakers can also be provided. Each of these components 1802-1812 is coupled to a communication infrastructure 1814, such as, a data bus or network.

Processor(s) 1802 operate in accordance with control logic 1804. Control logic 1804 is preferably a computer program, such that processor(s) 1802 operate in accordance with instructions contained in the computer program. For example, web server 500, customer service agent 510, browser 520, and browser 540 can be implemented as software (control logic 1804) executing on its own respective processor or multi-processor (processor(s) 1802).

Storage device 1806 can be any type of memory, preferably random access memory (RAM), and can also include a secondary memory or removable storage unit. Such a removable storage unit can be a floppy disk drive, a magnetic tape drive, an optical disk drive (CDROM), etc. that includes a computer usable storage medium having stored therein computer software and data. In alternative embodiments, secondary memory may include other similar means for allowing computer software and data to be loaded into computer system 1800. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to computer system 1800.

Communications interface 1808 allows software and data to be transferred between computer system 1800 and external devices (not shown). Examples of communications interface 1808 can include a modem, a network interface (such as an Ethernet card), a communications port, a PCMCIA slot and card, etc. Software and data transferred via communications interface 1808 are in the form of signals which can be electronic, electromagnetic, optical or other signals capable of being received by communications interface 1808. These signals are provided to communications interface 1808 via a channel (not shown). For example, such a channel can be implemented using wire or cable, fiber optics, a phone line, a wireless link, and/or an radio-frequency (RF) link.

In this document, the terms “computer program product”, “computer program medium” and “computer usable medium” are used to generally refer to media such as a removable storage device in storage device 1806 or carrier signals processed at communication interface 1808. Computer program products are means for providing software (e.g., computer programs) to computer system 1800.

Computer programs (also called computer program logic or control logic 1804) are generally stored in memory in storage device 1806 and executed therefrom. Computer programs can also be received via communications interface 1808. Such computer programs, when executed by processor(s) 1802, enable the computer system 1800 to perform the features of the present invention as discussed herein. In particular, the computer programs, when executed, enable the processor(s) 1802 to perform the features of the present invention. Accordingly, such computer programs represent controllers of the computer system 1800.

In an example where the invention is implemented using software, the software may be stored in a computer program product and loaded into computer system 1802 using a removable storage drive in storage device 1806 or communications interface 1808. The computer control logic (software), when executed by the processor(s) 1802, causes the processor(s) 1802 to perform the functions of the invention as described herein.

Also, in another example, the functionality of the invention is implemented primarily in hardware using, for example, hardware components such as application specific integrated circuits (ASICs). Implementation of the hardware state machine so as to perform the functions described herein will be apparent to persons skilled in the relevant art(s) (for example, processor(s) 1802 and control logic 1804 then represent hardware state machine(s)). In yet another example, the invention is implemented using a combination of hardware, firmware, and/or software.

The present invention as described above with respect to FIGS. 1 to 15 and 17 to 18, includes, but is not limited to, the subject matter of a second embodiment described further below with respect to FIG. 16.

Second Embodiment

Overview

According to a second embodiment, a method and system allows visitors of a Web site (includes internal or external Web sites, in other words site on an intranet, the Internet, or extranet) to be instantly contacted by a representative of the entity hosting a given Web site, without requiring the visitor to move to any special area. The connection to the representative maybe at the request of the visitor, maybe initiated by a representative either upon a visitor accessing a particular page or if the visitor meeting certain pre-defined criteria, or maybe initiated by a visitor accepting an invitation from an automated agent.

The advantage of this approach is that by visiting a Web site of an entity, a visitor has invited himself to an area to understand the products and services of the entity or the information provided by the entity. Since the entity is eager to sell the product to the customer or offer such information as found in the site, it makes sense to connect to the customer at an opportunity where it appears the customer is ready to converse with a representative. This can be done either based on the profile of the visitor (visitor works for a Fortune 500 company) or a criteria (visitor has spent 30 minutes understanding Product X). Once it has been determined that the visitor is ready to be contacted, a mechanism is used to make direct or indirect contact and get the interaction to begin.

The approach is also helpful even in situations where the entity managing a Web site does not have any commercial aspirations. The method and system described herein can be used to provide superior experience for visitors to a Web site, by providing for live interaction with a knowledgeable representative, by automatically detecting when such help is required and offering it at the right moment.

Steps Involved in Connecting a Representative to a Web Site Visitor

The parties involved in using the system described are:

a. Customer: The visitor will be referred to as a customer, though the visitor may not have any intention to be a customer at the time of visiting the site or may leave the site without becoming one.

b. Agent: An automated set of computer programs that manages the following tasks: task of identifying target customers who are qualified enough to warrant a live interaction with a real representative, interfacing with the customer to help him make a decision to connect, identify and locate the representative qualified to handle the customer, manage the queue of customers waiting to talk to their assigned representative, and facilitate the connection of the representative with the customer including locating the representative and notifying a customer wishes to speak to him. The Agent maybe optionally personified by using a human or robot oriented interface. For example the agent may announce to the customer that it is an automated program or pretend to be a real person who is making a connection (like a Receptionist helping a visitor to connect to the person they are visiting).

c. Representative: A person appointed by the Web site managers to help customers find product information, answer questions, and otherwise help in completing a sale of a product or service.

As shown in FIG. 16, the steps involved are:

a. Visitor enters the site (step 1610)

b. Agent starts monitoring what the customer is doing (step 1620).

c. Agent may prompt availability of help based on criteria (customer is fumbling or appears to be confused for instance) (step 1630).

d. Agent continues to check if customer is qualified to warrant a commercial interaction (step 1640).

e. If customer is qualified, agent initiates conversation with helpful comments and prompts for live connection to a representative (step 1642).

f. Customer accepts or declines the invitation (step 1650).

g. If Customer accepts, Agent places Customer on hold, and locates a Representative qualified to assist the customer. (Step 1660). Location and notification maybe by phone, beeper, E-mail or other means.

h. If Representative is busy, Agent manages the queue of customers. (Step 1662). If Representative is not available, locates a representative using methods described in “Method and System for establishing and conducting instant meetings where users connect and communicate using a variety of text and voice-supported devices” below. (Step 1664).

i. Agent connects the Representative to the Customer for instant interaction (step 1670).

Description of the Method and System

The System that will facilitate an instant connection for a Web site visitor to a representative will be a computer software program(s) and associated hardware, that will reside in a host system with input-output device. The Program will be loaded into the memory and will work with external systems, programs and hardware as and when required. The Program or System can be accessed or controlled from any device that can be directly or indirectly connected to the computer, and parts of the program will get loaded into such devices whenever required. The program will work with any device used to connect to a Web site (based on any internetworking protocol including but not limited to HTTP). Such device may be any audio-driven or text driven device including telephones, input-output device, hand-held organizers, television with input facilities (set-top box and input device attached to the television), computers, and other similar devices.

The Program will have access to a disk for storage and retrieval. All information required to connect a customer and representative automatically, including people information, history of current and previous meetings or interactions, general customer profiles, customer intelligence rules and other information on devices will be stored in the disk.

The System will also be connected to various hardware to provide the required connections to network with phone systems, television systems, radio, airwaves, Internet, and other networking systems.

Once the Program or System is active, it listens for the Web Server to get a request from a customer. Once the Web site page request comes in, the Agent Part of the Program creates a thread to monitor the customer. A thread is created for every single customer who visits the site.

Visitor Enters the Site

When the visitor enters the site, the agent program creates a dedicated thread for the visitor. This thread monitors every request made by the visitor (browser request) and logs to a memory or file. The agent may keep track of the customer by any of the following mode, if a secure site it notes and starts tracking by security certificate or ids, otherwise by network node id, IP address, host name or any other unique identifier.

Agent Starts Monitoring What the Customer is Doing

As the customer keeps making requests, the agent starts monitoring actively what the customer is doing. It may keep track of time spent on each page, the pattern of use, the direction of use, and the preferred areas in the Web site, and collect other data. These data is then used to evaluate various rules the Web site management may have set to evaluate a customer and decide on actions to be taken by the agent. The rules are defined in simple if-then conditions. For example, if customer goes back and forth through the same set of pages in quick succession, then it means he is confused. If customer is confused, Agent makes appearance and offers help.

Agent May Prompt Availability of Help Based on Criteria

Based on the rules, the agent makes its appearance to a customer in the form of a visual interface at an appropriate time, which may include an animated persona, or may simply be a simple text oriented interface. The Agent downloads itself into the Web page and may be employed using any downloadable technology including but not limited to Java, ActiveX, or Push technologies.

If Customer is not deemed commercially inclined at this stage but found to be in a state of needing help, the agent may act as a courtesy person to provide help in guiding the customer. The interaction may involve a simple statement like “I am Jill, your Courtesy Help Representative. If you would like to interact with a representative of this site let me know. If you have any questions, please type Help”. If customer requests help, the agent may provide the required information.

Agent Continues to Check if Customer is Qualified to Warrant a Real Interaction

After the agent has offered help for guiding the customer, the agent continues to monitor the customer for checking if customer reaches a state of needing help to facilitate a sale. The customer is deemed to be in a mental state of positively inclined to a sales pitch or talking to a representative.

If customer is qualified, agent initiates conversation with helpful comments and prompts for live connection to a representative.

Once the customer is deemed to have reached a state, where a commercial transaction becomes viable, or before that, the agent may prompt with a simple greeting. The agent then proceeds to interact with the customer to ask if the customer is interested in more information, has any questions, or would like to place an order. Depending on the response of the customer, the agent takes various actions, based on the rules set at the Web site. This may include attempting to help the customer through an automated agent, call the appropriate representative to take over, or go to a “hold-out as real pattern”.

The hold-out as real pattern involves the agent pretending to be the real person and engaging in a conversation, especially if the customer is still not ready to buy, to minimize the cost of the interaction. However, if the agent detects the customer cannot be helped without the assistance of a live person, it will immediately locate and notify the suitable representative, and the interaction is taken over by the live representative. The customer is not given any formal cues as to the change in the person/agent handling the interaction.

Customer Accepts or Declines the Invitation

If Customer is given a choice for the interaction with the agent, the customer may either accept or decline the invitation to interact with the representative or agent.

If Customer accepts, Agent places Customer on hold, and locates a Representative qualified to assist the customer.

If the Customer accepts the invitation to talk to a live representative, the agent may either continue to interact if it had given an impression of being a live person, or notify the customer that it will attempt to locate a live representative. Such notification to the customer may include expected waiting time, or an option of agent contacting the customer as soon as the representative is found. The second option allows the customer to do other tasks or continue browsing while they are on hold.

The agent then proceeds to check the database to find the suitable representative who is qualified to help the customer. Once it determines who the right person is, it employs methods and systems required for locating and notifying the representative of the customer in hold. Such notification may be using any device not limited to beeper, television, telephone including cellular and mobile, electronic mail, or facsimile.

If Representative is busy, Agent manages the queue of customers. Upon locating a representative if the agent finds out the representative is busy handling other customers, it will setup a queue and manage it. If a team of representatives is handling the interactions with customers, it will ensure the right person is serving the customers at the right time.

Agent connects the Representative to the Customer for Instant Interaction

Upon a representative becoming available, the agent will connect the customer and representative instantly. If the customer had requested notification, it will locate and notify them using the appropriate means including audio/visual notification, electronic mail, beeper or other suitable device. The representative and customer are now ready to begin the interaction.

The present invention, as described in embodiments above with respect to FIGS. 1 to 18, can be further used in combination with subject matter of a third embodiment related to establishing and conducting meetings as described further below. However, the present invention as described above with respect to FIGS. 1 to 18 is not intended to be limited to a combination with the subject matter of a third embodiment unless expressly recited in the claims. Further, the third embodiment relates to establishing and conducting meetings and can be used in a separate invention irrespective of the embodiments described above with respect to FIGS. 1 to 18.

Third Embodiment

Overview

Any person working even in a medium sized organization spends a lot of time in meetings everyday. The most common method to conduct meetings still remain face-to-face or over the phone. However, this method is very unsatisfactory when a person or persons (for the purposes herein a person will include an electronic agent acting on their behalf) need to connect with one or more persons or devices (including electronic agents) to get an opinion or resolve a matter urgently. Methods and systems are described to bring about a meeting of two or more people, where such persons could have access to a variety of devices, to allow them to communicate and conduct a meeting instantly.

A Method and System for establishing and conducting instant meetings where users connect and communicate using a variety of text and voice-supported devices is provided. Methods and systems are provided for establishing an instant meeting where many people can be invited at once and the meeting conducted instantaneously using a multitude of devices. The method and system would allow people to be identified, located, informed, setting up an acceptance mechanism, connect an invitee to the rest of the attendees, help the group communicate and conduct a meeting using a variety of devices which may include television, any input-output device such as a computer, hand-held devices, telephones etc.

Steps Involved in Conducting a Meeting Instantly

Any person (Person will include references to persons or electronic agents or devices that act on behalf of a person)wanting to establish a meeting in the present time (instantly) to conduct a conversation or communication has to follow one or more of the steps to connect instantly.

a. Connect to the System to initiate and conduct the meeting

b. Identify people to be involved in the meeting

c. System locates the people to notify the invitation

d. System invites the people to the meeting (Notification)

e. Processing the Acceptance or rejection of the person who was invited

f. Connecting or facilitating the transportation of the participant to the meeting location using a suitable device

g. Conducting the meeting which includes communicating using any device of choice

Description of the Method and System

The System that will facilitate an initiator (initiator covers more than one person if more than one person initiate the meeting) will be a computer software program and associated hardware, that will reside in a host system with input-output device. The Program will be loaded into the memory and will work with external systems, programs and hardware as and when required. The Program or System can be accessed or controlled from any device that can be directly or indirectly connected to the computer. Such device may be any audio-driven or text driven device including telephones, input-output device, hand-held organizers, television with input facilities (set-top box and input device attached to the television), computers, and other similar devices.

The Program will have access to a disk for storage and retrieval. All information required to setup a meeting, including people information, history of current and previous meetings, information on devices will be stored in the disk.

The System will also be connected to various hardware to provide the required connections to network with phone systems, television systems, radio, airwaves, Internet and other networking systems.

Once the Program or System is active, it listens for any request from an initiator to setup a meeting. Such a request could be placed through any networked source for receiving the information—a phone call, for instance. In such a case, the phone call will be picked up by a standard interface software and will communicate the contents of the call to the System. The System would then respond to the request and respond accordingly.

Method for Initiator to Connect to the System to Initiate and Conduct a Meeting

The initiator will connect to the system using any device capable of input-output of voice and/or text. The System would confirm the identity of the initiator using a security mechanism which may involve a password or other authentication scheme.

Once the initiator is authenticated a menu of choices is displayed or announced. Options will include setting up a meeting, querying information on past meetings, looking up people information etc.

Method for Identifying People Who Need to Attend a Instant Meeting

If the initiator chooses the option of setting up an instant meeting, the system would help in identifying the people who need to attend the meeting:

System will accept list of people or groups (Sales team, Plant managers) from the initiator

Propose list of people suitable for the meeting based on:

past history

topic provided

people who have notified the system they would like to be notified of any meeting that takes place based on the criteria of topic, attendees, other keyword.

The system would finalize the list of people who need to identified by allowing initiator to add or delete people to the list. It would also prompt known issues with attendees: vacations, known absence, lack of information to contact them. The initiator can also demand the system to list how the system proposes to notify attendees and modify the information for optimal results. Once the attendee accepts the final list of attendees the system would attempt to proceed to notify the attendees

Method for Notifying Attendees Who Need to Attend the Instant Meeting

For each attendee who needs to attend the meeting, the system would identify an optimal method to connect and notify instantly. The system would use past history as one factor in making this decision. It may also use a cost optimization module to figure the cost-effective method to connect to the attendee.

The System would proceed to first figure out the options available to connect to each attendee:

Check if initiator has provided any preferred mode of notification

Check database of people in the system to get instant contact information. This may involve finding the contact information to connect to any device that may be in proximity to the person who needs to be contacted. In the event, the attendee has no suitable device nearby it will attempt to locate known list of people who are known to the attendee to inform them. Any device with ability to notify the message can be used to notify the attendee. The device should have a display unit to display the message, or an audio unit to announce the message, or both, with the ability to receive data from an external source. A device can also be built specifically to handle this notification. Known devices that can handle this task include telephones including mobile/cellular phones, mobile two-way radios, hand-held computing devices including organizers, television, computers, any input-output device, beepers, fax machines.

The system may also used public databases of known locations, past and present, and may also connect to other external systems that provide location services to locate a device capable of notifying the attendee.

The system would notify the attendee with the following information either in speech mode or display the message depending on the capabilities of the device that is located near the attendee:

Method for Processing Attendees Acceptance/rejection Instant Meeting Invitation

If the attendee has a device capable of notifying the system of his acceptance or rejection of the meeting, the system would process the information received from the attendee and take further action.

Such decision would be passed back to the initiator to take further steps. For example, if key people do not attend the meeting, the initiator may decide to postpone or cancel the meeting. In such a case, the system would automatically notify all attendees of such action, based on the preference of the initiator.

Method for Facilitating Attendees to Connect to the Instant Meeting Using a Suitable Device

Once the notification has been processed and if the attendee accepts the invitation, the system would proceed to provide relevant information for the attendee to make a decision on the most useful device to use to join the meeting.

If the notification was done using a device that is not capable of two-way communication, then the system would help the attendee figure out the best way to connect to a suitable device. Such information may involve automatic steps for helping the attendee connect to the meeting using an appropriate device quickly. For example, if user received information by beeper that is not capable of two-way interaction, the beeper message may ask the attendee to check his electronic mail for further information. The electronic mail message sent to the attendee would provide an embedded program or link to connect to the meeting.

If attendee received the notification through a device capable of input-output that is supported by the system, the system would immediately connect the attendee to the meeting room. Such a meeting room would exist in the system in the virtual sense and the attendee would be able to identify the presence of others in the room. The system would use an appropriate security mechanism to confirm the identity of the attendee before permitting the entrance to the meeting room.

Method for Facilitating Attendees to Communicate During the Instant Meeting Using a Suitable Device

The system facilitates an attendee to communicate using any supported device that is capable of transmitting text that was created using an input device or spoken words. The System would handle the required text-to-speech or speech-to-text conversion, including other input that can be used to construct the words to speech, to display in the appropriate manner for all participants in the meeting. The System would also proceed to translate the communication to the appropriate language before providing it to a given attendee.

For example, A uses a standard computer and initiates a meeting inviting B and C. The system determines B can contacted through his television set since he is watching the television (this is determined by the presence of an active connection between a set-top box attached to the television and an external network), and C is sitting in a park with his mobile phone (determined by C's mobile phone number being available in the database). The System interrupts B during the television program, with an appropriate notification to join the meeting. B accepts the invitation and finds himself in a virtual room. B decides to use a keyboard connected by infrared to the output box connected to the television. C receives a call from the System informing of the meeting. C accepts the call and decides to use the phone. Once the meeting is in progress, A and B use the keyboard as an input device and read the conversation of the others in their display unit (for A the display unit is his monitor attached to his computer, for B the display unit is the television). C hears all the conversation, as the system converts all the written words to speech and announces it in a suitable manner for C to distinguish between A and B. To communicate, C speaks into his phone. The System automatically converts C's spoken words to text and displays it to A and B.

Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is Claimed is:

1. A method for providing live customer service between a customer and a customer service representative (CSR) in real-time over the World Wide Web, comprising the steps of:
(a) enabling a Web site for live customer service (CS);
(b) enabling a customer service window to be displayed on a browser of the customer visiting the CS enabled Web site;
(c) receiving a query input in the customer service window by the customer;
(d) routing the received query to a CSR;
(e) enabling a CSR window including the received query to be displayed on a browser of the CSR; and
(f) sending a response input in the CSR window by the CSR to the browser of the customer while the customer browses the World Wide Web.

2. The method of claim 1, further comprising the steps of:
determining whether a customer browsing the CS enabled Web site qualifies for live customer service prior to said enabling step (b); and
enabling only qualified customers browsing the CS enabled Web site to be provided live customer service over the World Wide Web according to steps (b) to (f).

3. The method of claim 2, wherein said customer qualifying determining step comprises the step of determining whether a customer status is known.

4. The method of claim 1, further comprising the step of:
gathering browsing data on the browsing activity of the customer.

5. The method of claim 4, further comprising the step of:
prompting the customer for help based on the gathered browsing data.

6. The method of claim 1, further comprising the step of:
generating a customer profile.

7. The method of claim 1, further comprising the steps of:
determining the level of customer service to be provided based at least upon one of the following: browsing data gathered while the customer browses the CS enabled Web site; a customer profile; and a policy of the CS enabled Web site; and
determining the contents of the customer service window based on the level of customer service to be provided.

8. The method of claim 1, wherein said customer service window enabling step (b) enables at least one of a service dialog window and a service form to be displayed on a browser of the customer visiting the CS enabled Web site.

9. The method of claim 8, wherein said customer service window enabling step (b) enables a service dialog window to be displayed on a browser of the customer visiting the CS enabled Web site when an express interactive customer service is provided and enables a service dialog window and a service form to be displayed on a browser of the customer visiting the CS enabled Web site when a full interactive customer service is provided.

10. The method of claim 8, wherein said customer service window enabling step (b) initially enables a service dialog window to be displayed on a browser of the customer visiting the CS enabled Web site to exchange messages with a CSR; and further comprising the step of enabling a service dialog window and a service form to be displayed on the browser of the customer visiting the CS enabled Web site when a transaction is to be completed which is more complex than exchanging messages.

11. The method of claim 1, further comprising the steps of:
polling the Web site after the query is input in the customer service window including issuing polling messages; and
notifying the customer while the customer is browsing the Web that a CSR has chosen to respond to the query input by the customer; wherein said notifying step notifies the customer in response to a polling message sent in said polling step.

12. The method of claim 1, wherein said routing step comprises intelligently routing the query to a CSR based on at least one of the following criteria: content, context, question, and qualifications.

13. The method of claim 12, wherein said intelligently routing step includes the steps of:
storing the query and a corresponding customer URL in a queue of pending customer queries;
matching the stored query to a CSR based on at least one of the following criteria: content, context, question, and qualifications; and
storing the query in a service queue capable of being displayed in the CSR service window by the matched CSR.

14. The method of claim 1, further comprising the step of analyzing the query against a knowledge base to generate a list of recommended answers for display in the CSR window.

15. The method of claim 1, wherein said CSR window enabling step (e) further comprises enabling a CSR window to be displayed that allows a CSR to access at least one of the following: data in the customer profile, a list of scripts, and a list of recommended answers.

16. The method of claim 1, wherein said CSR window enabling step (e) further comprises enabling a CSR window to be displayed that include a service dialog window, a comments window, a response entry window, and a menu bar having at least the following group of buttons: Queue button, Customer Details button, Recommend Answers button, Update Customer Profile button, and a Scripts button.

17. The method of claim 1, further comprising the step of:
managing a dialog between the customer and the CSR once a CSR has picked up a customer.

18. The method of claim 1, further comprising the steps of:
encapsulating the query input in the service window into a HyperText Transport Protocol (HTTP) message prior to sending the query input from a computer at the customer browser; and
encapsulating the response sent in sending step into a HTTP message prior to sending the response to the computer at the customer browser; and
de-encapsulating the HTTP message received at the computer at the customer browser to extract the response; whereby communication can occur through a firewall that allows HTTP traffic to pass.

19. The method of claim 1, further comprising the step of supervising communication between the customer and the CSR.

20. The method of claim 19, wherein said supervising step further comprises tracking customer service performance.

21. The method of claim 1, wherein said Web site enabling step (a) comprises the steps of:
providing a customer service agent at the Web server for executing steps (b) to (f); and
providing active content in a Web page at the Web site for executing at the customer browser to support customer service.

22. The method of claim 1, wherein said active content providing step provides a service applet that executes to read customer profile data, to encapsulate and deencapsulate messages in HTTP, and to poll the Web site.

23. A system for providing live customer service between a customer and a customer service representative (CSR) in real-time over the World Wide Web, comprising:
(a) means for enabling a Web site for live customer service (CS);
(b) means for enabling a customer service window to be displayed on a browser of the customer visiting the CS enabled Web site;
(c) means for receiving a query input in the customer service window by the customer;
(d) means for routing the received query to a CSR;
(e) means for enabling a CSR window including the received query to be displayed on a browser of the CSR; and
(f) means for sending a response input in the CSR window by the CSR to the browser of the customer while the customer browses the World Wide Web.

24. The system of claim 23, further comprising:
means for determining whether a customer browsing the CS enabled Web site qualifies for live customer service prior to said enabling by said (b) enabling means; and
means for enabling only qualified customers browsing the CS enabled Web site to be provided live customer service over the World Wide Web.

25. The system of claim 23, further comprising:
means for gathering browsing data on the browsing activity of the customer.

26. The system of claim 25, further comprising:
means for prompting the customer for help based on the gathered browsing data.

27. The system of claim 23, further comprising:
means for determining the level of customer service to be provided based upon at least one of the following: browsing data gathered while the customer browses the CS enabled Web site; a customer profile; and a policy of the CS enabled Web site; and
means for determining the contents of the customer service window based on the level of customer service to be provided.

28. The system of claim 23, wherein said customer service window enabling means (b) enables at least one of a service dialog window and a service form to be displayed on a browser of the customer visiting the CS enabled Web site.

29. The system of claim 28, wherein said customer service window enabling means (b) enables a service dialog window to be displayed on a browser of the customer visiting the CS enabled Web site when an express interactive customer service is provided and enables a service dialog window and a service form to be displayed on a browser of the customer visiting the CS enabled Web site when a full interactive customer service is provided.

30. The system of claim 23, further comprising:
means for polling the Web site after the query is input in the customer service window including issuing polling messages; and
means for notifying the customer while the customer is browsing the Web that a CSR has chosen to respond to the query input by the customer; wherein said notifying means notifies the customer in response to a polling message sent by said polling means.

31. The system of claim 23, wherein said routing means include:
means for storing the query and a corresponding customer URL in a queue of pending customer queries;
means for matching the stored query to a CSR based on at least one of the following criteria: content, context, question, and qualifications; and
means for storing the query in a service queue capable of being displayed in the CSR service window by the matched CSR.

32. The system of claim 23, further comprising:
means for analyzing the query against a knowledge base to generate a list of recommended answers for display in the CSR window.

33. The system of claim 23, wherein said CSR window enabling means (e) enables a CSR window to be displayed that allows a CSR to access at least one of the following: data in the customer profile, a list of scripts, and a list of recommended answers.

34. The system of claim 23, further comprising:
means for managing a dialog between the customer and the CSR once a CSR has picked up a customer.

35. The system of claim 23, further comprising:
means for encapsulating the query input in the service window into a HyperText Transport Protocol (HTTP) message prior to sending the query input from a computer at the customer browser; and
means for encapsulating the response sent in sending step into a HTTP message prior to sending the response to the computer at the customer browser; and
means for de-encapsulating the HTTP message received at the computer at the customer browser to extract the response; whereby communication can occur through a firewall that allows HTTP traffic to pass.

36. The system of claim 23, further comprising:
means for supervising communication between the customer and the CSR including; and
means for tracking customer service performance.

37. A system for providing live customer service (CS) between a customer and a customer service representative (CSR) in real-time over the World Wide Web (WWW), comprising:
a first computer that supports a customer browser;
a second computer that supports a CSR browser;
a memory that stores a CS enabled Web site having active content that executes in said first computer to support the live customer service; and
a server linked to said first and second computer over the WWW;
wherein said server executes a customer service agent in response to a customer browsing the CS enabled Web site stored in said memory; and
wherein the customer service agent enables a customer service window to be displayed by the customer browser, receives a query input in the customer service window by the customer, routes the received query to a CSR, enables a CSR window including the received query to be displayed on a browser of the CSR, and sends a response input in the CSR window by the CSR to the browser of the customer while the customer browses the World Wide Web.

38. The system of claim 37, wherein the customer service agent further comprises:
a service manager;
a matcher; and
a dialog manager; wherein:
the service manager enables the customer service window to be displayed by the customer browser and stores the query input in the customer service window by the customer in a first queue,
the matcher matches the stored query in said first queue to a CSR and stores transfers the query into a second queue,
the service manager enables a CSR window including the query stored in said second queue to be displayed on the browser of the CSR and transfer control to a dialog manager after the matcher has stored the query in said second queue; and
the dialog manager sends the response input in the CSR window by the CSR to the browser of the customer while the customer browses the World Wide Web.

39. A computer program product comprising a computer useable medium having computer program logic recorded thereon for enabling at least one processor in a server to provide live customer service (CS) between a customer and a customer service representative (CSR) in real-time over the World Wide Web (WWW), said computer program logic comprising:
first computer readable program code means for enabling said at least one processor to route a query input in a customer service window by the customer to a CSR; and
second computer readable program code means for enabling said at least one processor, in response to a polling by a computer of the customer, to send a response input in a CSR window by the CSR to the browser of the customer; whereby a customer can browse or perform other tasks after the query is input in the customer service window.

40. A method for providing live customer service in real-time over the World Wide Web, comprising the steps of:
enabling a customer service window including a dialog window to be displayed while a customer browses a Web site;
receiving a query entered in said dialog window by the customer;
routing the received query to a customer service representative; and
in response to a polling by a computer of the customer, sending a response to the received query from the customer service representative to the customer; whereby a customer can browse or perform other tasks after the query is input in the customer service window.

41. A method for providing customer service over the World Wide Web, comprising the steps of:
enabling a customer service window including a service form to be displayed while a visitor browses a Web site;
receiving customer information entered in fields of the service form by the visitor;
routing the visitor to a customer service representative based at least in part on said received customer information; and
establishing a person-to-person connection between the visitor and the customer service representative over the World Wide Web (WWW).

42. The method of claim 41, wherein said establishing step comprises:
establishing a secure person-to-person connection between the visitor and the customer service representative over the WWW.

43. The method of claim 42, wherein said establishing step comprises:
establishing a quasi-persistent link between the visitor and the customer service representative over the WWW.

44. A method for providing customer service over the World Wide Web, comprising the steps of:
monitoring a visitor who is browsing a Web site;
routing the visitor to a customer service representative; and
establishing a person-to-person connection between the visitor and the customer service representative over the World Wide Web.

45. The method of claim 44, wherein:
said routing step comprises routing the visitor to a customer service representative while the visitor browses the WWW; and
said establishing step comprises establishing a person-to-person connection between the visitor and the customer service representative while the visitor browses.

46. A method for providing communication between first and second users, comprising the steps of:
monitoring the first user who is browsing a Web site;
routing the first user to a second user; and
establishing a person-to-person connection between the first and second users over the World Wide Web.

47. A method for determining need for live interaction with a Web site visitor and facilitating such interaction comprising the steps of:
(a) determining if Web site visitors need assistance to use the Web site;
(b) determining if a Web site visitor is in a state to hear a sales pitch, or ready to place an order or perform any other task;
(c) automatically making contact with a Web site visitor using a live representative or an automated agent based on any criteria which may include: enabling commerce on the Web or providing a better experience in the Web site;
(d) accepting and processing the decision of the Web site visitor during the facilitation of instant connections;
(e) interacting with a visitor using an automated agent (computer programs) wherein the agent pretends to be a real person and interacts with the customer; and detecting when the agent can no longer handle the customer, and smoothly passing it on to a live representative without the customer being aware of such change; and
(f) facilitating the notification to a customer, when the customer is on hold waiting for a representative, using a variety of devices when the representative is ready to interact with the customer.

48. A method for establishing and conducting instant meetings where users connect and communicate using a variety of text and voice-supported devices comprising the steps of:
locating people and notifying them of an instant meeting about to occur, by locating a device closest to the people attending the meeting capable of accepting a notification, and making such notification;
accepting and processing the decision of each person notified;
facilitating an invitee who wishes to participate in the meeting to be connected to the meeting using a suitable device;
facilitating the communication in the meeting where participants use a variety of devices to communicate to each other, by automatically converting spoken words to text and text to spoken words and communicating the results to each attendee in the required form in either text or spoken words including translating to the required language for a participant to understand the proceedings; and
providing the requisite security to authenticate only authorized users are participating in an instant meeting where multiple devices are employed.
